(19) United States
(12) Patent Application Publication
(10) Pub. No.: US 2019/0230766 A1
(43) Pub. Date: Jul. 25, 2019

(54) ORGANIC ELECTROLUMINESCENT DEVICE

(71) Applicant: FUJI XEROX CO., LTD., Tokyo (JP)

(72) Inventors: Hajime SUGAHARA, Kanagawa (JP); Katsumi NUKADA, Kanagawa (JP); Hidekazu HIROSE, Kanagawa (JP)

(73) Assignee: FUJI XEROX CO., LTD., Tokyo (JP)

(21) Appl. No.: 16/133,724

(22) Filed: Sep. 18, 2018

(30) Foreign Application Priority Data
Jan. 22, 2018 (JP) 2018-008170

(51) Int. Cl. H05B 33/14; G03G 5/047; G03G 5/05; G03G 5/147

(52) U.S. Cl. CPC H05B 33/14; G03G 5/047; G03G 5/0532; G03G 5/14717; G03G 5/0596; G03G 5/14791; G03G 5/0592

(57) ABSTRACT

An organic electroluminescent device includes an anode and a cathode that are a pair of electrodes, at least one of the electrodes being transparent or translucent; and an organic compound layer interposed between the electrodes, the organic compound layer including at least one layer containing a cured film obtained from a composition that contains an amine compound having six or more crosslinkable groups. The cured film has a residual film ratio of 90% or more after a condition described below, and a rate of change in surface roughness Ra of the cured film before and after the condition described below is 0.99 or more: condition: placing toluene on the cured film and leaving toluene thereon for 30 seconds.

### CROSS-REFERENCE TO RELATED APPLICATIONS

This application is based on and claims priority under 35 USC 119 from Japanese Patent Application No. 2018-008170 filed Jan. 22, 2018.

### BACKGROUND

### (i) Technical Field

The present disclosure relates to an organic electroluminescent device.

### (ii) Related Art

Studies on charge-transporting films used in organic electroluminescent devices and other electronic devices, such as organic transistors and organic solar cells, are now being actively pursued.

Japanese Laid Open Patent Application Publication No. 2011-086798 discloses “an organic EL device having a device structure that includes an organic layer and paired electrodes that sandwich the organic layer, the organic layer being having a multilayer structure that includes at least an emission layer and a hole transporting layer formed of a network polymer obtained by crosslinking polymerization of organic molecules having crosslinkable substituents, in which some of the crosslinkable substituents in the network polymer remain unreacted”.

Japanese Laid Open Patent Application Publication No. 2016-082242 discloses “an organic photoelectric conversion device that includes an anode, a cathode, an active layer disposed between the anode and the cathode, and a hole-injecting layer disposed between the anode and the active layer, in which the cathode is an electrode that contains an electrically conductive nanosubstance, and the hole-injecting layer is a layer that has a residual film ratio of 80% or more in a residual film ratio measurement after a water rinsing treatment described below”.

Japanese Patent No. 4947219 discloses “an organic electroluminescent device that includes, on a substrate, an anode, a cathode, and an organic layer disposed between the anode and the cathode, in which the cathode includes a hole-transporting layer and an emission layer, the hole-transporting layer is a layer formed by forming a film by using an organic device composition that contains two or more crosslinkable compounds, and then polymerizing the crosslinkable compounds, in which at least two of the crosslinkable compounds differ from one another in the number of crosslinkable groups, the at least two crosslinkable compounds that differ from one another in the number of crosslinkable groups are a compound having a hole-transporting portion and a singular molecular weight and a polymer having a hole-transporting portion and a repeating unit, and the emission layer is a layer formed by a wet film-forming method and containing a low-molecular-weight light-emitting material having a molecular weight of 10,000 or less”.

### SUMMARY

Some organic electroluminescent devices are equipped with an organic compound layer that has a cured film obtained from a composition containing an amine compound having less than six crosslinkable groups. Such organic electroluminescent devices sometimes have short lifetime.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an organic electroluminescent device including an anode and a cathode that are a pair of electrodes, at least one of the electrodes being transparent or translucent; and an organic compound layer interposed between the electrodes, the organic compound layer including at least one layer containing a cured film obtained from a composition that contains an amine compound having six or more crosslinkable groups. The cured film has a residual film ratio of 90% or more after a condition described below, and a rate of change in surface roughness Ra of the cured film before and after the condition described below is 0.99 or more: condition: placing toluene on the cured film and leaving toluene thereon for 30 seconds.

### BRIEF DESCRIPTION OF THE DRAWINGS

Exemplary embodiments of the present disclosure will be described in detail based on the following figures, wherein:

FIG. 1 is a schematic cross-sectional view of one example of an organic electroluminescent device according to an exemplary embodiment;

FIG. 2 is a schematic cross-sectional view of one example of an organic electroluminescent device according to an exemplary embodiment;

FIG. 3 is a schematic cross-sectional view of one example of an organic electroluminescent device according to an exemplary embodiment; and

FIG. 4 is a schematic cross-sectional view of one example of an organic electroluminescent device according to an exemplary embodiment.

### DETAILED DESCRIPTION

The exemplary embodiments of the disclosure will now be described. These description and examples illustrate exemplary embodiments and do not limit the scope of the disclosure.

In this description, when the amount of a component in a layer or in a composition is referred and when there two or more types of substances that correspond to that component in the layer or in the composition, the amount is the total amount of the two or more types of the substances in the layer or in the composition unless otherwise noted.

An organic electroluminescent device of this exemplary embodiment includes a pair of electrodes, which are an anode and a cathode, at least one of which is transparent or translucent; an organic compound layer that is sandwiched between the electrodes and that includes at least one cured film obtained from a composition that contains an amine compound having six or more crosslinkable groups. After a treatment of placing toluene on the cured film and leaving toluene thereon for 30 seconds, the residual film ratio is 90% or more, and the rate of change in surface roughness Ra of the cured film before and after the treatment is 0.99 or more.

Some organic electroluminescent devices of related art are known to include a cured film obtained from a composition that contains an amine compound having crosslinkable groups. However, amine compounds known heretofore are substituted amine compounds having less than six crosslinkable groups, as described in Japanese Laid Open Patent Application Publication No. 2014-56106. Substituted amine compounds having less than six crosslinkable groups have a tendency to promote intramolecular crosslinking rather than the intended intermolecular crosslinking in preparing the organic compound layer by forming a cured film. This is because the number of crosslinkable groups is small. An organic compound layer that includes a cured film formed by intramolecular crosslinking of the amine compound is easily affected by the solvent and drying under heating in forming an overlying film on the cured film by application, and thus the interface between the cured film and the overlying film on the cured film tends to be disturbed. When the interface is disturbed, a phenomenon such as inhibition of charge exchange between the stacked films readily occurs, and, as a consequence, fluctuation of the electric resistance of the organic electroluminescent device tends to increase. As a result, the lifetime of the organic electroluminescent device tends to be short.

Meanwhile, the organic electroluminescent device of this exemplary embodiment has an organic compound layer that contains at least one layer containing a cured film obtained from a composition that contains an amine compound having six or more crosslinkable groups. Thus, the number of crosslinking points increases, and, in forming the cured film, intermolecular crosslinking of the amine compound is promoted. Because intermolecular crosslinking of the amine compound is promoted, the residual film ratio after the treatment of placing toluene on the cured film and leaving toluene thereon for 30 seconds is 90% or more, and the rate of change in surface roughness Ra of the cured film before and after this treatment is 0.99 or more. In other words, the thickness and the surface of the cured film are kept even and smooth, and, thus, disturbance of the interface between the cured film and an overlying film stacked on the cured film is easily suppressed. Presumably as a result, the fluctuation of the electric resistance of the organic electroluminescent device is easily reduced, and the lifetime of the organic electroluminescent device is extended.

### Organic Compound Layer

The organic compound layer will now be described.

The organic compound layer of this exemplary embodiment includes at least one cured film obtained from a composition that contains an amine compound described below.

### Properties of Cured Film

The properties of the cured film will now be described.

According to the cured film of this exemplary embodiment, the residual film ratio after the treatment of placing toluene on the cured film and leaving toluene thereon for 30 seconds is 90% or more, and the rate of change in surface roughness Ra of the cured film before and after this treatment is 0.99 or more.

The cured film of this exemplary embodiment, which satisfy these properties, extend the lifetime of the organic electroluminescent device.

The residual film ratio may be 90% or more, 95% or more, 98% or more, or 99% or more.

The rate of change in surface roughness Ra before and after the treatment of placing toluene and leaving toluene thereon for 30 seconds is 0.99 or more and may be 1.

The surface roughness Ra of the cured film after the treatment of placing toluene and leaving toluene thereon for 30 seconds may be 25 nm or less, may be 20 nm or less, or may be 15 nm or less.

When the surface roughness Ra of the cured film after the treatment of placing toluene and leaving toluene thereon for 30 seconds is 25 nm or less, the surface of the cured film is smooth. Thus, the disturbance of the interface between the cured film and the overlying film stacked on the cured film is likely to be suppressed, and the lifetime of the organic electroluminescent device is likely to be extended.

The treatment of placing toluene and leaving toluene thereon for 30 seconds is described below.

On a 2.5 cm×2.5 cm cured film to be measured, 2 ml of toluene is placed and is left thereon for 30 seconds. After 30 seconds of leaving toluene on the cured film, spinning is performed at 200 rpm for 10 seconds and at 2000 rpm for 20 seconds to shake the toluene off.

The residual film ratio is calculated by using the equation below by measuring the absorbance of the cured film before and after the treatment described above with U-4000 produced by Hitachi Corporation.

Residual film ratio=absorbance after treatment of placing toluene and leaving toluene thereon for 30 seconds/absorbance before treatment of placing toluene and leaving toluene thereon for 30 seconds×100(%) The surface roughness Ra of the cured film is measured by the following method.

First, the cured film after the treatment of placing toluene and leaving toluene thereon for 30 seconds is cut with a cutter or the like to obtain a measurement sample.

The surface roughness Ra of this measurement sample is measured with a surface profiler, DEKTAK-6M (produced by ULVAC Inc.).

The measurement was conducted under the conditions set forth in JIS B 0601 (1994), with measurement length=4 mm, measurement speed=0.3 mm/s, cut-off wavelength=0.8 mm, and type of cut-off=Gaussian.

The rate of change in surface roughness Ra is determined from the equation below by measuring the surface roughness Ra before and after the above-described treatment by the procedure described above.

Rate of change in surface roughness Ra=surface roughness Ra after treatment of placing toluene and leaving toluene thereon for 30 seconds/surface roughness Ra before treatment of placing toluene and leaving toluene thereon for 30 seconds

The cured film of this exemplary embodiment may have a volume resistivity of 1×10⁵ Ω·cm or more and 1×10¹⁵ Ω·cm or less, 1×10⁵ Ω·cm or more and 1×10¹³ Ω·cm or less, 1×10⁵ Ω·cm or more and 1×10¹⁰ Ω·cm or less, or 1×10 Ω·cm or more and 1×10⁹ Ω·cm or less.

When the volume resistivity of the cured film is 1×10⁵ Ω·cm or more and 1×10¹⁵ Ω·cm or less, charges are efficiently transported, and an organic electroluminescent device with extended lifetime can be easily obtained.

The volume resistivity of the cured film is measured by the following procedure.

A 100 nm-thick, 1 cm² gold electrode serving as a counter electrode is vacuum-sputtered onto a cured film so as to prepare a sample for measuring the resistivity. By using SI 1287 Electrochemical Interface (produced by TOYO Corporation) as a power supply, SI 1260 Impedance/Gain Phase Analyzer (produced by TOYO Corporation) as an amperemeter, 1296 Dielectric Interface (produced by TOYO Corporation) as a current amplifier, a 1 V AC voltage is applied from a high-frequency-side within a range of 1 MHz to 1 mHz to measure the AC impedance of each sample. The profile of the Cole-Cole plot obtained by this measurement is fitted to an R-C parallel equivalent circuit so as to obtain the volume resistivity (Ω·cm).

### Cured Film

The cured film will now be described.

The cured film is configured from a composition that contains an amine compound having six or more crosslinkable groups. This composition may contain other additives from the viewpoints of improving the external quantum efficiency, improving the charge injection amount, etc.

The cured film is obtained by optionally using, in addition to the amine compound having six or more crosslinkable groups, a radical generator such as a thermal radical generator and a photo-radical generator.

The content of the amine compound having six or more crosslinkable groups may be set according to the usage. From the viewpoint of extending the lifetime of the organic electroluminescent device, the content relative to a total solid content of 100 parts by mass in the composition may be 50 parts by mass or more and 99 parts by mass or less, 60 parts by mass or more and 99 parts by mass or less, or 70 parts by mass or more and 99 parts by mass or less.

### Amine Compound Having Six or More Crosslinkable Groups

The amine compound having six or more crosslinkable groups will now be described.

The amine compound of this exemplary embodiment is a compound having a skeleton that has charge-transporting ability, and six or more crosslinking groups linked to the skeleton either directly or through linking groups.

The number of crosslinkable groups linked to the amine compound is 6 or more, may be 6 or more and 12 or less, may be 6 or more and 10 or less, may be or 6 or more and 8 or less.

When there are six or more crosslinkable groups in the amine compound and when a cured film is formed therefrom, intermolecular crosslinking is promoted, and disturbance of the interface between the cured film and the overlying layer stacked on the cured film is suppressed. Thus, an organic electroluminescent device with an extended lifetime is obtained.

The skeleton having charge-transporting ability may be any skeleton derived from a compound having hole-transporting ability or electron-transporting ability.

Examples of the skeleton derived from a compound having hole-transporting ability include subunits derived from compounds having hole-transporting ability described below.

The crosslinkable groups may be radically polymerizable functional groups. Examples thereof include functional groups having groups containing at least a carbon-carbon double bond. A specific example of the crosslinkable group is a group that includes at least one selected from a vinyl group, a vinylether group, a vinylthioether group, a vinylphenyl group, an acryloyl group, a methacryloyl group, and derivatives thereof.

The linking group may be any group that can link the skeleton having charge-transporting ability and crosslinkable groups, and may have any one or combination of a linear structure, a branched structure, and a cyclic structure.

Examples of the linking group include one linking group selected from an alkylene group, —C═C—, —C(═O)—, —N(R)—, —O—, —S—, a trivalent group obtained by removing three hydrogen atoms from methane, and a trivalent group obtained by removing three hydrogen atoms from ethylene, and a divalent or higher linking group in which two or more selected from the foregoing are combined.

From the viewpoint of extending the lifetime of the organic electroluminescent device, the amine compound having six or more crosslinkable groups may be an amine compound that contains vinylphenyl groups as crosslinkable groups.

Among the above-described amine compounds that contain vinylphenyl groups as crosslinkable groups, the amine compound having six or more crosslinkable groups may be a compound represented by general formula (1) from the viewpoint of the hole-transporting ability, the polymerizability, the solvent resistance, the coatability, etc.

The compound represented by general formula (1) is a compound in which vinylphenyl groups, which are crosslinkable groups, are linked to a hole-transporting subunit represented by F through linking groups L.

In general, the hole-transporting ability of a hole-transporting compound tends to be degraded as the number of the crosslinking sites (the number of crosslinkable groups) of the hole-transporting compound increases. This is presumably because, as the number of crosslinking sites (the number of crosslinkable groups) of the hole-transporting compound increases, distortion occurs in the hole-transporting subunit during polymerization.

In contrast, the compound represented by general formula (1) has a structure in which vinylphenyl groups serving as crosslinkable groups are linked to the hole-transporting subunit F through linking groups L, and thus, presence of the linking groups L suppresses distortion of the hole-transporting subunit during polymerization, and thus both the polymerizability and the hole-transporting ability can be achieved.

Moreover, a polymer of the compound represented by general formula (1) has excellent hole-transporting ability, and thus, charge migration smoothly occurs between electron-transporting sites. Presumably as a result, an organic compound layer (cured film) that contains a polymer of the compound represented by general formula (1) has an increased amount of charges in the layer and a decreased resistance. Thus, the compound represented by general formula (1) is useful as a material to be used in a cured film of an organic electroluminescent device.

Compared to hole-transporting compounds that have only (meth)acryl groups as the crosslinkable groups, the hole-transporting compound having vinylphenyl groups as the crosslinkable groups are considered to have excellent crosslinking group solvent resistance and compound applicability. From this viewpoint also, the compound represented by general formula (1) is useful as a material for a composition for forming a cured film.

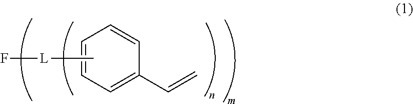

In general formula (1), F represents a hole-transporting subunit, L represents one linking group selected from an alkylene group, —C═C—, —C(═O)—, —N(R)—, —O—, —S—, a trivalent group obtained by removing three hydrogen atoms from methane, and a trivalent group obtained by removing three hydrogen atoms from ethylene, or a linking group having a valence of (n+1) obtained by combining two or more of the foregoing, and R represents a hydrogen group, an alkyl group, an aryl group, or an aralkyl group. In general formula (1), m represents an integer of 1 or more and 6 or less, and n represents an integer of 1 or more and 3 or less. However, (m+n) is an integer of 6 or more.

When there are more than one L in a molecule, L may be the same or different from one another.

The hole-transporting subunit represented by F may be any subunit derived from a compound having hole-transporting ability. Specific examples thereof include subunits derived from compounds having hole-transporting ability, such as triarylamine compounds, hydrazone compounds, and carbazole compounds. Among these, a subunit derived from a triarylamine compound, which has excellent charge mobility, oxidation stability, etc., may be used.

The linking group represented by L is divalent, trivalent, or quadrivalent, or may be divalent or trivalent.

The divalent linking group represented by L may be a divalent linking group obtained by combining an alkylene group and at least one selected from —C═C—, —C(═O)—, —N(R)—, —O—, and —S—. The alkylene group may be a linear alkylene group with 1 or more and 6 or less carbon atoms or a linear alkylene group with 1 or more and 4 or less carbon atoms.

Examples of the divalent linking group represented by L are as follows. In the linking groups described below, “*” is the site linked to F, and a, b, and c each represent the number of repeated methylene groups.

*—(CH₂)a-O—(CH₂)b-
*—(CH₂)a-O—(CH₂)c-O—(CH₂)b-
*—(CH₂)a-C(═O)—O—(CH₂)b-
*—(CH₂)a-C(═O)—N(R)—(CH₂)b-
*—(CH₂)a-C(═O)—S—(CH₂)b-
*—(CH₂)a-N(R)—(CH₂)b-
*—(CH₂)a-S—(CH₂)b-
*—O—(CH₂)a-O—(CH₂)b-
*—CH═CH—(CH₂)a-O—(CH₂)b-

### *—CH═CH—C(═O)—O—(CH₂)b-

Examples of the trivalent linking group represented by L are as follows. In the linking groups described below, “*” is the site linked to F, and a, b, c, d, e, and f each represent the number of repeated methylene groups.

*—(CH₂)a-CH[—C(═O)—O—(CH₂)b-]₂
*—(CH₂)a-CH[—CH₂—O—(CH₂)b-]₂
*—CH═C[—C(═O)—O—(CH₂)b-]₂
*—CH═C[—(CH₂)c-O—(CH₂)b-]₂
*—(CH₂)a-CH [—C(═O)—N(R)—(CH₂)b-]₂
*—(CH₂)a-CH [—C(═O)—S—(CH₂)b-]₂
*—(CH₂)a-CH[—(CH₂)c-N(R)—(CH₂)b-]₂
*—(CH₂)a-CH[—(CH₂)c-S—(CH₂)b-]₂
*—O—(CH₂)d-CH[—(CH₂)c-O—(CH₂)b-]₂
*—(CH₂)f-O—(CH₂)d-CH[—(CH₂)c-O—(CH₂)b-]₂

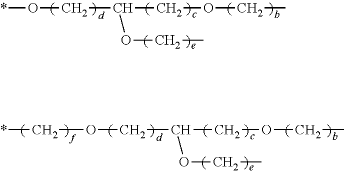

Examples of the quadrivalent linking group represented by L are as follows. In the linking groups described below, “*” is the site linked to F, and b, c, and g each represent the number of repeated methylene groups.

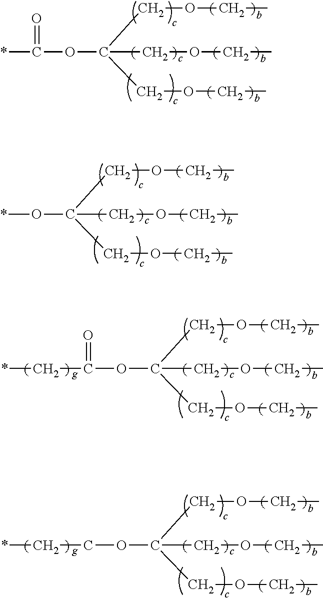

The compound represented by general formula (1) may be a compound having, as a hole-transporting subunit, a subunit derived from a triarylamine compound. Specifically, compounds represented by general formula (2) may be used.

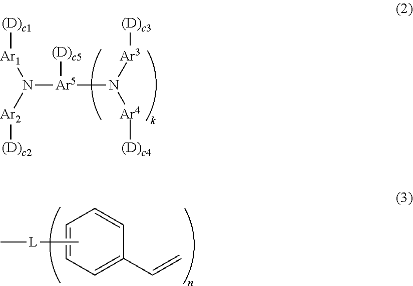

In general formula (2), Ar¹ to Ar⁴ each independently represent a substituted or unsubstituted aryl group, and Ar⁵ represents a substituted or unsubstituted aryl group or a substituted or unsubstituted arylene group. Furthermore, k represents 0 or 1, c1 to c5 each independently represent an integer of 0 or more and 2 or less, and the total of c1 to c5 is 1 or more. D represents a group represented by general formula (3). In general formula (3), L represents one linking group selected from an alkylene group, —C═C—, —C(═O)—, —N(R)—, —O—, —S—, a trivalent group obtained by removing three hydrogen atoms from methane, and a trivalent group obtained by removing three hydrogen atoms from ethylene, or a linking group having a valence of (n+1) obtained by combining two or more of the foregoing, R represents a hydrogen group, an alkyl group, an aryl group, or an aralkyl group, and n represents an integer of 1 or more and 3 or less. However, the number of vinylphenyl groups serving as crosslinkable groups is 6 or more.

In general formula (2), when the total of c1 to c5 is 2 or more, more than one D (in other words, the group represented by general formula (3)) present in a molecule may be the same or different from one another.

In general formula (2), the substituted or unsubstituted aryl groups represented by Ar¹ to Ar⁴ may be the same or different from one another.

Examples of the substituents other than D (in other words, the group represented by general formula (3)) in Ar¹ to Ar⁴ include an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom.

Ar¹ to Ar⁴ may each be one of structural formulae (11) to (17). In structural formulae (11) to (17), “-(D)c” is used to generally indicate “-(D)_{C1}” to “-(D)_{C4}” linked to Ar¹ to Ar⁴.

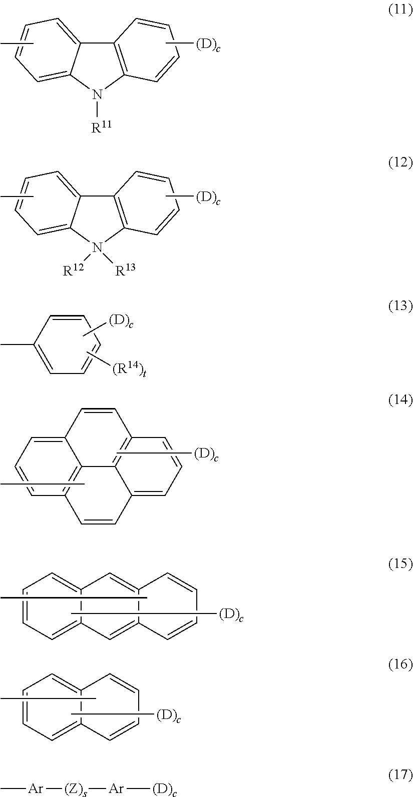

In structural formula (11), R¹¹ represents at least one selected from a hydrogen atom, an alkyl group with 1 or more and 4 or less carbon atoms, an unsubstituted phenyl group, a phenyl group substituted with an alkoxy group or an alkyl group with 1 or more and 4 or less carbon atoms, and an aralkyl group with 7 or more and 10 or less carbon atoms.

In structural formula (12), R¹² and R¹³ each independently represent at least one selected from a hydrogen atom, an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom.

In structural formula (13), R¹⁴ represents at least one selected from an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom. Furthermore, t represents an integer of 0 or more and 4 or less.

In structural formula (17), Ar represents a substituted or unsubstituted arylene group. Ar may be structural formula (18) or (19).

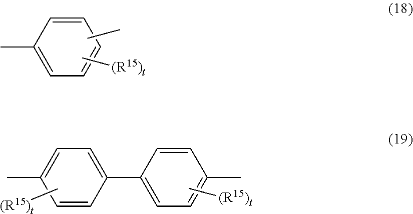

In structural formulae (18) and (19), R¹⁵ represents at least one selected from an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom, and t represents an integer of 0 or more and 4 or less.

In structural formula (17), Z represents a divalent linking group, and s represents 0 or 1. Z may be one of structural formulae (21) to (28).

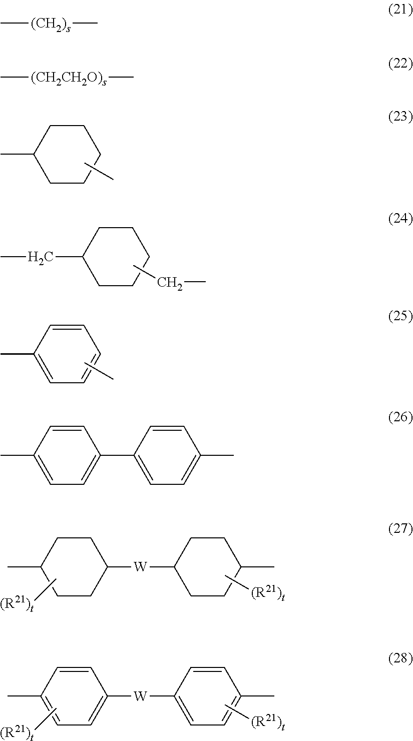

In structural formula (21), s represents an integer of 1 or more and 10 or less.

In structural formula (22), s represents an integer of 1 or more and 10 or less.

In structural formulae (27) and (28), R²¹ represents at least one selected from an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom, t represents an integer of 0 or more and 4 or less, and W represents a divalent linking group. W may be one of structural formulae (31) to (39). In structural formula (38), s represents an integer of 0 or more and 3 or less.

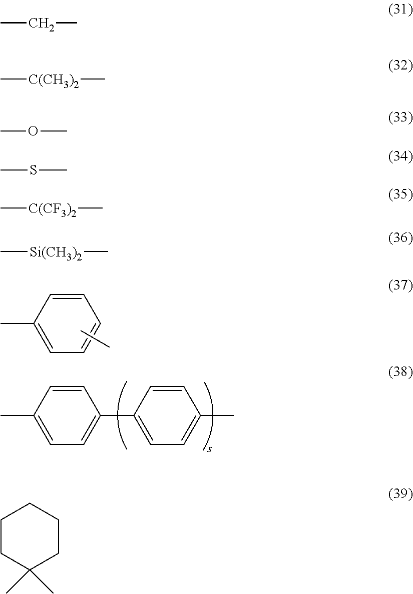

Ar⁵ in general formula (2) is a substituted or unsubstituted aryl group when k is 0, and is a substituted or unsubstituted arylene group when k is 1.

Examples of the substituted or unsubstituted aryl group represented by Ar⁵ include those aryl groups given as examples for Ar¹ to Ar⁴. Examples of the substituents in the aryl group include an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom.

When Ar⁵ is a substituted or unsubstituted arylene group, C5 may be 0, in other words, D (that is, the group represented by general formula (3)) may not be linked to Ar⁵. Examples of the substituted or unsubstituted arylene group represented by Ar⁵ include structural formulae (41) to (46).

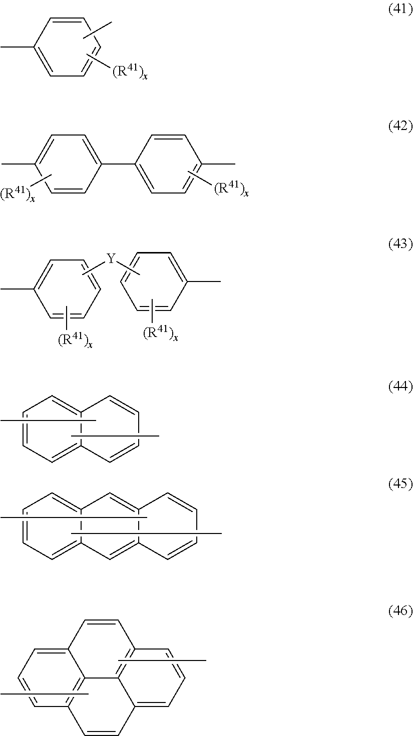

In structural formulae (41) to (43), R⁴¹ represents at least one selected from an alkyl group with 1 or more and 4 or less carbon atoms, an alkoxy group with 1 or more and 4 or less carbon atoms, an unsubstituted phenyl group, a phenyl group substituted with an alkoxy group or an alkyl group with 1 or more and 4 or less carbon atoms, an aralkyl group with 7 or more and 10 or less carbon atoms, and a halogen atom, and x represents an integer of 0 or more and 4 or less. In structural formula (43), Y represents a divalent linking group, and Y may be one of structural formulae (51) to (60). In structural formula (51), y represents an integer of 1 or more and 4 or less.

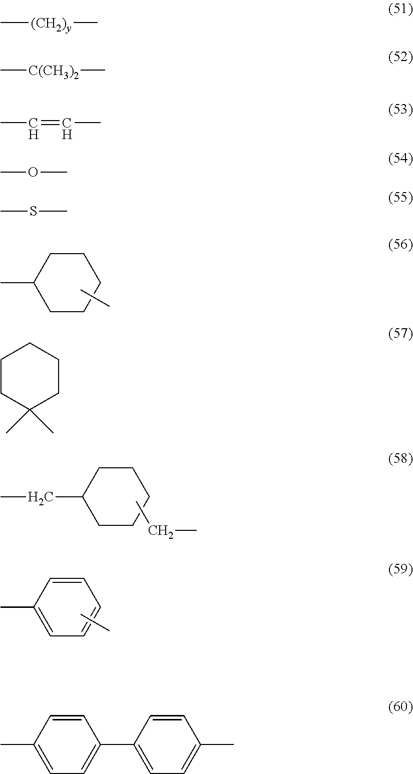

In general formula (2), c1 to c5 each independently represent an integer of 0 or more and 2 or less, and the total of c1 to c5 is 1 or more. In other words, the compound represented by general formula (2) has one or more groups represented by general formula (3). The total number of groups represented by general formula (3) in the molecule may be 1 or more and 4 or less, 1 or more and 3 or less, or 2. In general formula (3), L and n are respective the same as L and n in general formula (1).

From the viewpoint of extending the lifetime of the organic electroluminescent device, the group represented by general formula (3) may be a group having at least one of a group represented by general formula (A-1) and a group represented by general formula (A-2).

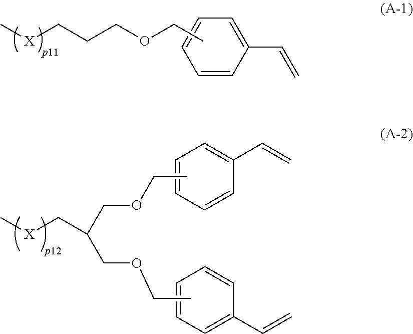

In general formulae (A-1) and (A-2), X each independently represent a linking group selected from an alkylene group, —C═C—, —C(═O)—, —N(R)—, —O—, and —S—, or a divalent linking group obtained by combining two or more of the foregoing. R represents a hydrogen atom, an alkyl group, an aryl group, or an aralkyl group. Moreover, p11 and p12 each independently represent an integer of 0 or 1.

Here, the groups represented by general formulae (A-1) and (A-2) may have X representing an alkylene group or p11 and p12 representing 0.

In general formulae (A-1) and (A-2), the alkylene group represented by X may be a linear alkylene group with 1 or more and 6 or less carbon atoms, a linear alkylene group with 1 or more and 3 or less carbon atoms, or a linear alkylene group with 1 or 2 carbon atoms.

In general formulae (A-1) and (A-2), in the linking group represented by X, examples of the alkyl group represented by R in —N(R)— include a linear alkyl group with 1 or more and 12 or less carbon atoms (or 5 or more and 10 or less carbon atoms) and a branched alkyl group with 3 or more and 10 or less (or 5 or more and 10 or less) carbon atoms.

In the general formulae (A-1) and (A-2), in the linking group represented by X, the aryl group represented by R in —N(R)— may be an aryl group with 6 or more and 18 or less carbon atoms, and examples thereof include a phenyl group, a biphenyl group, a 1-naphthyl group, a 2-naphthyl group, a 9-anthryl group, and a 9-phenanthryl group. Among these, a phenyl group may be used.

In general formulae (A-1) and (A-2), in the linking group represented by X, examples of the aralkyl group represented by R in —N(R)— include an aralkyl group with 7 or more and 15 or less carbon atoms (or 7 or more and 14 or less carbon atoms).

When there are more than one group represented by general formulae (A-1) and (A-2) in the molecule, the groups represented by general formulae (A-1) and (A-2) may be the same or different from one another.

From the viewpoint of extending the lifetime of the organic electroluminescent device, the amine compound represented by general formula (2) may be compounds represented by general formulae (B-1), (B-2), and (B-3).

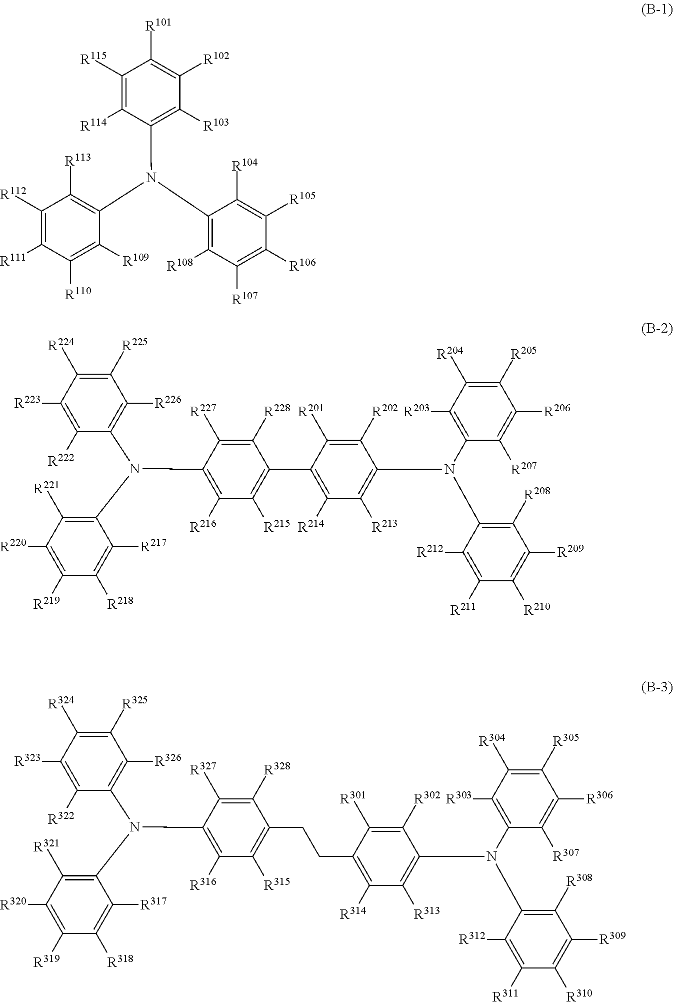

In general formula (B-1), R¹⁰¹, R¹⁰², R¹⁰³, R¹⁰⁴, R¹⁰⁵, R¹⁰⁶, R¹⁰⁷, R¹⁰⁸, R¹⁰⁹, R¹¹⁰, R¹¹¹, R¹¹², R¹¹³, R¹¹⁴, and R¹⁰⁵ each independently represent a hydrogen atom, a halogen atom, an alkyl group, an alkoxy group, an aryl group, a group represented by general formula (A-1), or a group represented by general formula (A-2). However, the compound is to have six or more crosslinkable groups described above.

In general formula (B-2), R²⁰¹, R²⁰², R²⁰³, R²⁰⁴, R²⁰⁵, R²⁰⁶, R²⁰⁷, R²⁰⁸, R²⁰⁹, R²¹⁰, R²¹¹, R²¹², R²¹³, R²¹⁴, R²¹⁵, R²¹⁶, R²¹⁷, R²¹⁸, R²¹⁹, R²²⁰, R²²¹, R²²², R²²³, R²²⁴, R²²⁵, R²²⁶, R²²⁷, and R²²⁸ each independently represent a hydrogen atom, a halogen atom, an alkyl group, an alkoxy group, an aryl group, a group represented by general formula (A-1), or a group represented by general formula (A-2). However, the compound is to have six or more crosslinkable groups described above.

In general formula (B-3), R³⁰¹, R³⁰², R³⁰³, R³⁰⁴, R³⁰⁵, R³⁰⁶, R³⁰⁷, R³⁰⁸, R³⁰⁹, R³¹⁰, R³¹¹, R³¹², R³¹³, R³¹⁴, R³¹⁵, R³¹⁶, R³¹⁷, R³¹⁸, R³¹⁹, R³²⁰, R³²¹, R³²², R³²³, R³²⁴, R³²⁵, R³²⁶, R³²⁷, and R³²⁸ each independently represent a hydrogen atom, a halogen atom, an alkyl group, an alkoxy group, an aryl group, a group represented by general formula (A-1), or a group represented by general formula (A-2). However, the compound is to have six or more crosslinkable groups described above.

Examples of the halogen atoms represented by R¹⁰¹ to R¹¹⁵, R²⁰¹ to R²²⁸, or R³⁰¹ to R³⁰² in general formulae (B-1), (B-2), and (B-3) include a fluorine atom, a chlorine atom, a bromine atom, and an iodine atom.

Examples of the alkyl groups represented by R¹⁰¹ to R¹¹⁵, R²⁰¹ to R²²⁸, or R³⁰¹ to R³²⁸ in general formulae (B-1), (B-2), and (B-3) include substituted or unsubstituted alkyl groups.

Examples of the unsubstituted alkyl group include a linear alkyl group with 1 or more and 12 or less carbon atoms (or 5 or more and 10 or less carbon atoms) and a branched alkyl group with 3 or more and 10 or less carbon atoms (or 5 or more and 10 or less carbon atoms).

Examples of the linear alkyl group with 1 or more and 12 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, and an n-dodecyl group.

Examples of the branched alkyl group with 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group and an ethyl group may be used as the unsubstituted alkyl group.

Examples of the substituents in the alkyl group include an alkoxy group with 1 or more and 4 or less carbon atoms, an unsubstituted aryl group, a phenyl group substituted with an alkoxy group or an alkyl group with 1 or more and 4 or less carbon atoms, an aralkyl group with 7 or more and 10 or less carbon atoms, a hydroxyl group, a carboxyl group, a nitro group, and a halogen atom (chlorine, iodine, or bromine).

Examples of the alkoxy group in the alkoxy-substituted alkyl group include the same groups as those alkoxy groups represented by R¹⁰¹ to R¹¹⁵, R²⁰¹ to R²²⁸, or R³⁰¹ to R³²⁸ described below. Examples of the aryl group in the aryl-substituted alkyl group include the same groups as those unsubstituted aryl groups represented by R¹⁰¹ to R¹¹⁵, R²⁰¹ to R²²⁸, or R³⁰¹ to R³²⁸ described below.

Examples of the alkoxy groups represented by R¹⁰¹ to R¹¹⁵, R²⁰¹ to R²²⁸, or R³⁰¹ to R³²⁸ in general formulae (B-1), (B-2), and (B-3) include linear or branched alkoxy groups with 1 or more and 10 or less carbon atoms (or 1 or more and 6 or less, or 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group. Among these, a methoxy group may be used as the alkoxy group.

Examples of the aryl groups represented by R¹⁰¹ to R¹¹⁵, R²⁰¹ to R²²⁸, or R³⁰¹ to R³²⁸ in general formulae (B-1), (B-2), and (B-3) include substituted or unsubstituted aryl groups.

The unsubstituted aryl group may be, for example, an aryl group with 6 or more and 30 or less carbon atoms. Examples thereof include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a terphenyl group, a quarterphenyl group, o-, m-, and p-tolyl groups, a xylyl group, o-, m- and p-cumenyl groups, a mesityl group, a pentalenyl group, a binaphthalenyl group, a ternaphthalenyl group, a quarternaphthalenyl group, a heptalenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarteranthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubicenyl group, a coronenyl group, a trinaphthylenyl group, a heptaphenyl group, a heptacenyl group, a pyranthrenyl group, and an ovalenyl group. Among these, a phenyl group may be used.

Examples of the substituent in the aryl group include an alkyl group, an alkoxy group, and a halogen atom (chlorine, iodine, or bromine). Examples of the alkyl group in the alkyl-substituted aryl group include the same groups as those unsubstituted alkyl groups represented by R¹¹ to R¹⁷ in general formula (ET). Examples of the alkoxy group in the alkoxy-substituted aryl group include the same groups as those alkoxy groups represented by R¹⁰¹ to R¹¹⁵, R²⁰¹ to R²²⁸, or R³⁰¹ to R³²⁸ described above.

Specific examples of the amine compound having crosslinkable groups are as follows.

The amine compound having crosslinkable groups is not limited by these examples.

In Tables 1, 2, and 3, specific examples of the skeleton (may also be referred to as “parent nucleus” hereinafter) obtained by removing the groups including the crosslinkable groups from the compounds represented by general formulae (B-1), (B-2), and (B-3) are described.

In Tables 1, 2, and 3, “*” indicates groups containing crosslinkable groups (groups represented by general formulae (A-1) and (A-2)).

Examples of the specific structures of the crosslinkable groups (groups represented by general formulae (A-1) and (A-2)) linked to the skeleton having hole-transporting ability are described below.

Table 4 indicates combinations of the compounds described in Tables 1, 2, and 3 and the specific structures of the groups containing crosslinkable groups linked to the skeleton having hole-transporting ability (groups represented by general formulae (A-1) and (A-2)) described below.

TABLE 1

| Compound No | R¹⁰¹ | R¹⁰² | R¹⁰³ | R¹⁰⁴ | R¹⁰⁵ | R¹⁰⁶ | R¹⁰⁷ | R¹⁰⁸ | R¹⁰⁹ | R¹¹⁰ | R¹¹¹ | R¹¹² | R¹¹³ | R¹¹⁴ | R¹¹⁵ |
|---|---|---|---|---|---|---|---|---|---|---|---|---|---|---|---|
| 2-1 | * | H | H | H | H | * | H | H | H | H | * | H | H | H | H |
| 2-2 | * | CH₃ | H | H | H | * | H | H | H | H | * | H | H | H | H |
| 2-3 | * | CH₃ | H | H | H | * | CH₃ | H | H | H | * | H | H | H | H |
| 2-4 | * | CH₃ | H | H | H | * | CH₃ | H | H | H | * | H | CH₃ | H | H |
| 2-5 | * | H | H | H | CH₃ | * | H | H | H | H | * | CH₃ | H | H | H |
| 2-6 | * | H | CH₃ | H | H | * | H | H | H | H | * | H | H | H | CH₃ |
| 2-7 | * | CH₃ | H | H | H | * | H | H | H | H | * | H | H | H | H |
| 2-8 | * | CH₃ | H | H | H | * | H | H | H | H | * | H | H | CH₃ | H |
| 2-9 | * | C₂H₅ | H | H | H | * | C₂H₅ | H | H | H | * | H | C₂H₅ | H | H |
| 2-10 | * | H | C₂H₅ | H | H | * | H | H | H | H | * | H | H | H | H |
| 2-11 | H | * | H | H | H | * | H | H | H | H | * | H | H | H | H |
| 2-12 | H | * | H | H | H | * | H | H | H | H | * | H | H | H | CH₃ |
| 2-13 | CH₃ | * | H | H | H | * | H | H | H | H | * | H | H | H | H |
| 2-14 | H | * | CH₃ | H | H | * | H | H | H | H | * | H | H | H | H |
| 2-15 | H | * | H | H | H | * | H | H | H | H | * | H | H | CH₃ | H |
| 2-16 | H | * | H | H | H | H | H | H | H | H | * | H | H | H | C₂H₅ |
| 2-17 | * | H | H | * | H | * | H | H | * | H | * | H | H | H | H |
| 2-18 | * | CH₃ | H | * | H | * | H | H | * | H | * | H | H | H | H |
| 2-19 | * | H | CH₃ | * | H | * | H | H | * | H | * | H | H | H | H |
| 2-20 | * | CH₃ | H | * | H | * | H | H | * | H | * | H | H | CH₃ | H |
| 2-21 | * | CH₃ | H | * | H | H | H | H | * | H | * | H | H | H | H |
| 2-22 | * | C₂H₅ | H | * | H | * | H | H | * | H | * | H | H | H | CH₃ |
| 2-23 | * | H | C₂H₅ | * | H | H | H | H | * | H | * | H | H | H | H |
| 2-24 | * | C₂H₅ | H | * | H | * | H | H | * | H | * | H | H | H | C₂H₅ |
| 2-25 | * | H | H | * | H | * | H | H | * | H | * | H | H | * | H |

TABLE 2

| Compound No | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ | R²¹¹ | R²¹² | R²¹³ | R²¹⁴ | R²¹⁵ |
|---|---|---|---|---|---|---|---|---|---|---|---|---|---|---|---|
| 3-1 | H | H | H | H | * | H | H | H | H | * | H | H | H | H | H |
| 3-2 | H | H | H | H | * | H | H | H | H | * | H | CH₃ | H | H | H |
| 3-3 | H | H | H | H | * | H | H | H | H | * | H | H | H | H | H |
| 3-4 | H | H | H | H | * | H | H | H | H | * | H | CH₃ | H | H | H |
| 3-5 | H | H | CH₃ | H | * | H | H | H | H | * | H | H | H | H | H |
| 3-6 | H | H | H | CH₃ | * | H | H | H | H | * | H | H | H | H | H |
| 3-7 | H | H | H | H | * | CH₃ | H | H | H | * | H | H | H | H | H |
| 3-8 | H | H | H | H | * | H | CH₃ | H | H | * | H | H | H | H | H |
| 3-9 | H | H | CH₃ | H | * | H | H | CH₃ | H | * | H | H | H | H | H |
| 3-10 | H | H | CH₃ | H | * | H | H | H | CH₃ | * | H | H | H | H | H |
| 3-11 | H | H | CH₃ | H | * | H | H | H | H | * | CH₃ | H | H | H | H |
| 3-12 | H | H | CH₃ | H | * | H | H | H | H | * | H | CH₃ | H | H | H |
| 3-13 | H | H | CH₃ | H | * | H | H | H | H | * | H | H | H | H | H |
| 3-14 | H | H | CH₃ | H | * | H | H | H | H | * | H | H | H | H | H |
| 3-15 | H | H | CH₃ | H | * | H | H | H | H | * | H | H | H | H | H |
| 3-16 | H | H | CH₃ | H | * | H | H | H | H | * | H | H | H | H | H |
| 3-17 | H | H | C₂H₅ | H | * | H | H | H | H | * | H | H | H | H | H |
| 3-18 | H | H | H | C₂H₅ | * | H | H | H | H | * | H | H | H | H | H |
| 3-19 | H | H | H | H | * | C₂H₅ | H | H | H | * | H | H | H | H | H |
| 3-20 | H | H | H | H | * | H | C₂H₅ | H | H | * | H | H | H | H | H |
| 3-21 | H | H | C₂H₅ | H | * | H | H | C₂H₅ | H | * | H | H | H | H | H |
| 3-22 | H | H | C₂H₅ | H | * | H | H | H | C₂H₅ | * | H | H | H | H | H |
| 3-23 | H | H | C₂H₅ | H | * | H | H | H | H | * | C₂H₅ | H | H | H | H |
| 3-24 | H | H | C₂H₅ | H | * | H | H | H | H | * | H | C₂H₅ | H | H | H |
| 3-25 | H | H | H | H | * | H | H | H | * | H | H | H | H | H | H |

| Compound No | R²¹⁶ | R²¹⁷ | R²¹⁸ | R²¹⁹ | R²²⁰ | R²²¹ | R²²² | R²²³ | R²²⁴ | R²²⁵ | R²²⁶ | R²²⁷ | R²²⁸ |
|---|---|---|---|---|---|---|---|---|---|---|---|---|---|
| 3-1 | H | H | H | * | H | H | H | H | * | H | H | H | H |
| 3-2 | H | H | H | * | H | H | H | H | * | H | H | H | H |
| 3-3 | H | CH₃ | H | * | H | H | H | H | * | H | H | H | H |
| 3-4 | H | CH₃ | H | * | H | H | H | H | * | H | H | H | H |
| 3-5 | H | H | H | * | H | H | H | H | * | H | H | H | H |
| 3-6 | H | H | H | * | H | H | H | H | * | H | H | H | H |
| 3-7 | H | H | H | * | H | H | H | H | * | H | H | H | H |
| 3-8 | H | H | H | * | H | H | H | H | * | H | H | H | H |
| 3-9 | H | H | H | * | H | H | H | H | * | H | H | H | H |
| 3-10 | H | H | H | * | H | H | H | H | * | H | H | H | H |
| 3-11 | H | H | H | * | H | H | H | H | * | H | H | H | H |
| 3-12 | H | H | H | * | H | H | H | H | * | H | H | H | H |
| 3-13 | H | H | H | * | H | H | CH₃ | H | * | H | H | H | H |
| 3-14 | H | H | H | * | H | H | H | CH₃ | * | H | H | H | H |
| 3-15 | H | H | H | * | H | H | H | H | * | CH₃ | H | H | H |
| 3-16 | H | H | H | * | H | H | H | H | * | H | CH₃ | H | H |
| 3-17 | H | H | H | * | H | H | H | H | * | H | H | H | H |
| 3-18 | H | H | H | * | H | H | H | H | * | H | H | H | H |
| 3-19 | H | H | H | * | H | H | H | H | * | H | H | H | H |
| 3-20 | H | H | H | * | H | H | H | H | * | H | H | H | H |
| 3-21 | H | H | H | * | H | H | H | H | * | H | H | H | H |
| 3-22 | H | H | H | * | H | H | H | H | * | H | H | H | H |
| 3-23 | H | H | H | * | H | H | H | H | * | H | H | H | H |
| 3-24 | H | H | H | * | H | H | H | H | * | H | H | H | H |
| 3-25 | H | H | H | * | H | H | H | * | H | H | H | H | H |

TABLE 3

| Compound No | R³⁰¹ | R³⁰² | R³⁰³ | R³⁰⁴ | R³⁰⁵ | R³⁰⁶ | R³⁰⁷ | R³⁰⁸ | R³⁰⁹ | R³¹⁰ | R³¹¹ | R³¹² | R³¹³ | R³¹⁴ | R³¹⁵ |
|---|---|---|---|---|---|---|---|---|---|---|---|---|---|---|---|
| 4-1 | H | H | H | H | * | H | H | H | H | * | H | H | H | H | H |
| 4-2 | H | H | H | H | * | H | H | H | H | * | H | CH₃ | H | H | H |
| 4-3 | H | H | H | H | * | H | H | H | H | * | H | H | H | H | H |
| 4-4 | H | H | H | H | * | H | H | H | H | * | H | CH₃ | H | H | H |
| 4-5 | H | H | CH₃ | H | * | H | H | H | H | * | H | H | H | H | H |
| 4-6 | H | H | H | CH₃ | * | H | H | H | H | * | H | H | H | H | H |
| 4-7 | H | H | H | H | * | CH₃ | H | H | H | * | H | H | H | H | H |
| 4-8 | H | H | H | H | * | H | CH₃ | H | H | * | H | H | H | H | H |
| 4-9 | H | H | CH₃ | H | * | H | H | CH₃ | H | * | H | H | H | H | H |
| 4-10 | H | H | CH₃ | H | * | H | H | H | CH₃ | * | H | H | H | H | H |
| 4-11 | H | H | CH₃ | H | * | H | H | H | H | * | CH₃ | H | H | H | H |
| 4-12 | H | H | CH₃ | H | * | H | H | H | H | * | H | CH₃ | H | H | H |
| 4-13 | H | H | CH₃ | H | * | H | H | H | H | * | H | H | H | H | H |
| 4-14 | H | H | CH₃ | H | * | H | H | H | H | * | H | H | H | H | H |
| 4-15 | H | H | CH₃ | H | * | H | H | H | H | * | H | H | H | H | H |
| 4-16 | H | H | CH₃ | H | * | H | H | H | H | * | H | H | H | H | H |
| 4-17 | H | H | C₂H₅ | H | * | H | H | H | H | * | H | H | H | H | H |
| 4-18 | H | H | H | C₂H₅ | * | H | H | H | H | * | H | H | H | H | H |
| 4-19 | H | H | H | H | * | C₂H₅ | H | H | H | * | H | H | H | H | H |
| 4-20 | H | H | H | H | * | H | C₂H₅ | H | H | * | H | H | H | H | H |
| 4-21 | H | H | C₂H₅ | H | * | H | H | C₂H₅ | H | * | H | H | H | H | H |
| 4-22 | H | H | C₂H₅ | H | * | H | H | H | C₂H₅ | * | H | H | H | H | H |
| 4-23 | H | H | C₂H₅ | H | * | H | H | H | H | * | C₂H₅ | H | H | H | H |
| 4-24 | H | H | C₂H₅ | H | * | H | H | H | H | * | H | C₂H₅ | H | H | H |
| 4-25 | H | H | H | H | * | H | H | H | * | H | H | H | H | H | H |

| Compound No | R³¹⁶ | R³¹⁷ | R³¹⁸ | R³¹⁹ | R³²⁰ | R³²¹ | R³²² | R³²³ | R³²⁴ | R³²⁵ | R³²⁶ | R³²⁷ | R³²⁸ |
|---|---|---|---|---|---|---|---|---|---|---|---|---|---|
| 4-1 | H | H | H | * | H | H | H | H | * | H | H | H | H |
| 4-2 | H | H | H | * | H | H | H | H | * | H | H | H | H |
| 4-3 | H | CH₃ | H | * | H | H | H | H | * | H | H | H | H |
| 4-4 | H | CH₃ | H | * | H | H | H | H | * | H | H | H | H |
| 4-5 | H | H | H | * | H | H | H | H | * | H | H | H | H |
| 4-6 | H | H | H | * | H | H | H | H | * | H | H | H | H |
| 4-7 | H | H | H | * | H | H | H | H | * | H | H | H | H |
| 4-8 | H | H | H | * | H | H | H | H | * | H | H | H | H |
| 4-9 | H | H | H | * | H | H | H | H | * | H | H | H | H |
| 4-10 | H | H | H | * | H | H | H | H | * | H | H | H | H |
| 4-11 | H | H | H | * | H | H | H | H | * | H | H | H | H |
| 4-12 | H | H | H | * | H | H | H | H | * | H | H | H | H |
| 4-13 | H | H | H | * | H | H | CH₃ | H | * | H | H | H | H |
| 4-14 | H | H | H | * | H | H | H | CH₃ | * | H | H | H | H |
| 4-15 | H | H | H | * | H | H | H | H | * | CH₃ | H | H | H |
| 4-16 | H | H | H | * | H | H | H | H | * | H | CH₃ | H | H |
| 4-17 | H | H | H | * | H | H | H | H | * | H | H | H | H |
| 4-18 | H | H | H | * | H | H | H | H | * | H | H | H | H |
| 4-19 | H | H | H | * | H | H | H | H | * | H | H | H | H |
| 4-20 | H | H | H | * | H | H | H | H | * | H | H | H | H |
| 4-21 | H | H | H | * | H | H | H | H | * | H | H | H | H |
| 4-22 | H | H | H | * | H | H | H | H | * | H | H | H | H |
| 4-23 | H | H | H | * | H | H | H | H | * | H | H | H | H |
| 4-24 | H | H | H | * | H | H | H | H | * | H | H | H | H |
| 4-25 | H | H | H | * | H | H | H | * | H | H | H | H | H |

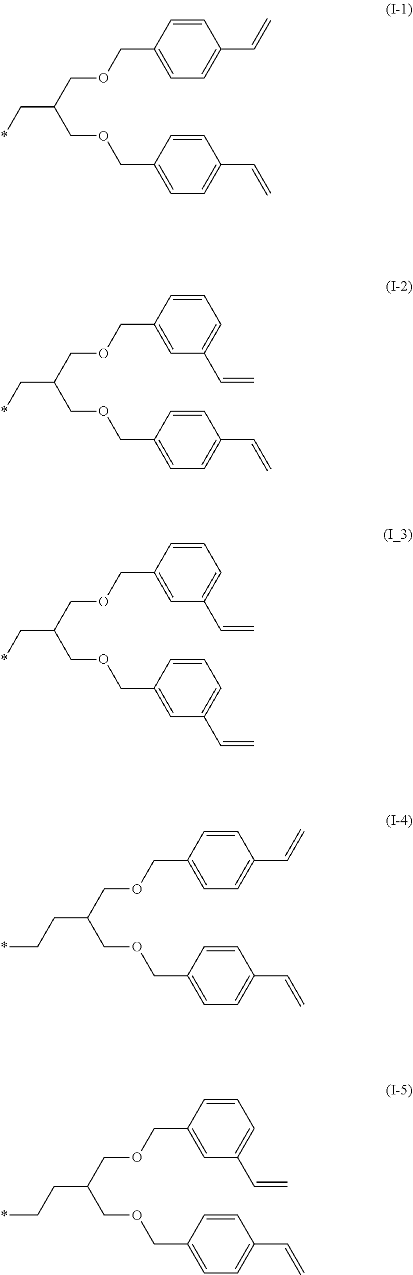 [SMILES: *CC(COCc1ccc(C=C)cc1)COCc1ccc(C=C)cc1 ; *CC(COCc1ccc(C=C)cc1)COCc1cccc(C=C)c1 ; *CC(COCc1cccc(C=C)c1)COCc1cccc(C=C)c1 ; *CCC(COCc1ccc(C=C)cc1)COCc1ccc(C=C)cc1 ; *CCC(COCc1ccc(C=C)cc1)COCc1cccc(C=C)c1]

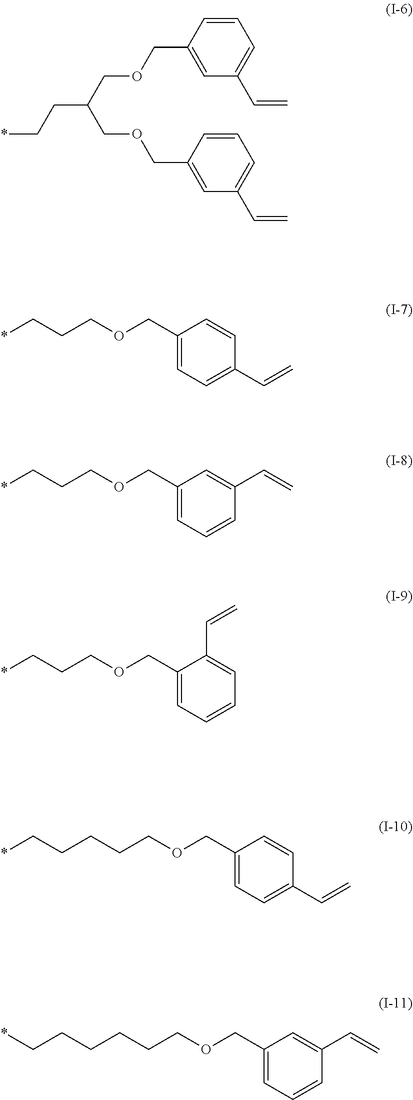 [SMILES: *CCC(COCc1cccc(C=C)c1)COCc1cccc(C=C)c1 ; *CCCOCc1ccc(C=C)cc1 ; *CCCOCc1cccc(C=C)c1 ; *CCCOCc1ccccc1C=C ; *CCCCCOCc1ccc(C=C)cc1 ; *CCCCCCOCc1cccc(C=C)c1]

TABLE 4

| Compound | Parent nucleus | Crosslinkable group |
|---|---|---|
| CTM-1 | 2-1 | (I-1) |
| CTM-2 | 2-2 | (I-1) |
| CTM-3 | 2-3 | (I-1) |
| CTM-4 | 2-4 | (I-1) |
| CTM-5 | 2-5 | (I-2) |
| CTM-6 | 2-6 | (I-3) |
| CTM-7 | 2-7 | (I-4) |
| CTM-8 | 2-8 | (I-5) |
| CTM-9 | 2-9 | (I-6) |
| CTM-10 | 2-10 | (I-4) |
| CTM-11 | 2-11 | (I-4) |
| CTM-12 | 2-12 | (I-4) |
| CTM-13 | 2-13 | (I-4) |
| CTM-14 | 2-14 | (I-4) |
| CTM-15 | 2-15 | (I-4) |
| CTM-16 | 3-1 | (I-1) |
| CTM-17 | 3-1 | (I-1), (I-7) |
| CTM-18 | 3-2 | (I-1) |
| CTM-19 | 3-3 | (I-1), (I-8) |
| CTM-20 | 3-4 | (I-1) |
| CTM-21 | 3-5 | (I-2) |
| CTM-22 | 3-6 | (I-3) |
| CTM-23 | 3-7 | (I-4), (I-9) |
| CTM-24 | 3-20 | (I-5) |
| CTM-25 | 3-21 | (I-6), (I-10) |
| CTM-26 | 3-22 | (I-4) |
| CTM-27 | 3-23 | (I-4), (I-11) |
| CTM-28 | 4-1 | (I-1) |
| CTM-29 | 4-1 | (I-1), (I-7) |
| CTM-30 | 4-2 | (I-1) |
| CTM-31 | 4-3 | (I-1) |
| CTM-32 | 4-4 | (I-1), (I-8) |
| CTM-33 | 4-5 | (I-2) |
| CTM-34 | 4-6 | (I-3) |
| CTM-35 | 4-7 | (I-1), (I-9) |
| CTM-36 | 4-12 | (I-4) |
| CTM-37 | 4-13 | (I-1), (I-10) |
| CTM-38 | 4-14 | (I-5) |
| CTM-39 | 4-15 | (I-6) |
| CTM-40 | 4-16 | (I-1), (I-11) |

In the compounds having more than one crosslinkable group indicated in Table 4, the combination of the type and position of the crosslinkable group are as follows.

CTM-17: R²⁰⁵ and R²²⁴ each represent (I-1), and R²¹⁰ and R²¹⁹ each represent (I-7).
CTM-19: R²⁰⁵ and R²²⁴ each represent (I-1), and R²¹⁰ and R²¹⁹ each represent (I-8).
CTM-23: R²⁰⁵ and R²²⁴ each represent (I-4), and R²¹⁰ and R²¹⁹ each represent (I-9).
CTM-25: R²⁰⁵ and R²²⁴ each represent (I-6), and R²¹⁰ and R²¹⁹ each represent (I-10).
CTM-27: R²⁰⁵ and R²²⁴ each represent (I-4), and R²¹⁰ and R²¹⁹ each represent (I-11).
CTM-29: R³⁰⁵ and R³²⁴ each represent (I-1), and R³¹⁰ and R³¹⁹ each represent (I-7).
CTM-32: R³⁰⁵ and R³²⁴ each represent (I-l), and R³¹⁰ and R³¹⁹ each represent (I-8).
CTM-35: R³⁰⁵ and R³²⁴ each represent (I-1), and R³¹⁰ and R³¹⁹ each represent (I-9).
CTM-37: R³⁰⁵ and R³²⁴ each represent (I-1), and R³¹⁰ and R³¹⁹ each represent (I-10).
CTM-40: R³⁰⁵ and R³²⁴ each represent (I-1), and R³¹⁰ and R³¹⁹ each represent (I-11).

Examples of the methods for synthesizing the compounds represented by general formulae (B-1), (B-2), and (B-3) include the synthetic methods described in Japanese Laid Open Patent Application Publication No. 2013-43841, paragraph [0126], Japanese Laid Open Patent Application Publication No. 2013-60422, paragraph [0070], and Japanese Laid Open Patent Application Publication No. 2013-60572, paragraphs [0099] to [0101].

The composition that forms the cured film of the exemplary embodiment may be obtained by using one type of an amine compound having crosslinkable groups or by using two or more types of such amine compounds.

### Other Additives

The composition that forms the cured film may contain, in addition to the amine compound having crosslinkable groups, other additives.

From the viewpoint of extending the lifetime of the organic electroluminescent device, at least one selected from a thermal radical generator and a photo-radical generator may be further contained as the additive in the composition.

The composition of the exemplary embodiment may contain at least one selected from a light-emitting material, a coloring compound, a hole-transporting material, a hole-injecting material, an electron-transporting material, and an electron-injecting material. Specific examples of these materials are described below.

When at least one selected from a thermal radical generator and a photo-radical generator is used to obtain a cured film of a composition containing an amine compound having crosslinkable groups, at least one selected from a thermal radical generator and a derivative thereof and a photo-radical generator and a derivative thereof is introduced into the cured film. An organic compound layer that contains such a cured film has excellent mechanical strength and thus is suitable for stacking.

Here, the “derivative of the thermal radical generator” means a product obtained after the thermal radical generator generates a radical, or to a polymer having a terminal to which the thermal radical generator is bonded.

Here, the “derivative of the photo-radical generator” means a product obtained after the photo-radical generator generates a radical, or to a polymer having a terminal to which the photo-radical generator is bonded.

Examples of the thermal radical generator include azo compounds and organic peroxides.

Examples of the commercially available products of the thermal radical generator include azo-based initiators such as V-30 (10-hour half-life temperature: 104° C.), V-40 (10-hour half-life temperature: 88° C.), V-59 (10-hour half-life temperature: 67° C.), V-601 (10-hour half-life temperature: 66° C.), V-65 (10-hour half-life temperature: 51° C.), V-70 (10-hour half-life temperature: 30° C.), VF-096 (10-hour half-life temperature: 96° C.), Vam-110 (10-hour half-life temperature: 111° C.), and Vam-111 (10-hour half-life temperature: 111° C.) (products up to here produced by Wako Pure Chemical Industries, Ltd.), and OT_{AZO}-15 (10-hour half-life temperature: 61° C.), OT_{AZO}-30, AIBN (10-hour half-life temperature: 65° C.), AMBN (10-hour half-life temperature: 67° C.), ADVN (10-hour half-life temperature: 52° C.), ACVA (10-hour half-life temperature: 68° C.) (products up to here produced by Otsuka Chemical Co., Ltd.); PERTETRA A, PERHEXA HC, PERHEXA C, PERHEXA V, PERHEXA 22, PERHEXA MC, PERBUTYL H, PERCUMYL H, PERCUMYL P, PERMENTA H, PEROCTA H, PERBUTYL C, PERBUTYL D, PERHEXYL D, PEROYL IB, PEROYL 355, PEROYL L, PEROYL SA, NYPER BW, NYPER BMT-K40/M, PEROYL IPP, PEROYL NPP, PEROYL TCP, PEROYL OPP, PEROYL SBP, PERCUMYL ND, PEROCTA ND, PERHEXYL ND, PERBUTYL ND, PERBUTYL NHP, PERHEXYL PV, PERBUTYL PV, PERHEXA 250, PEROCTA O, PERHEXYL O, PERBUTYL O, PERBUTYL L, PERBUTYL 355, PERHEXYL I, PERBUTYL I, PERBUTYL E, PERHEXA 25Z, PERBUTYL A, PERHEXYL Z, PERBUTYL ZT, AND PERBUTYL Z (products up to here produced by NOF CORPORATION), KAYAKETAL AM-C55, TRIGONOX 36-C75, LAUROX, PERKADOX L-W75, PERKADOX CH-50L, TRIGONOX TMBH, KAYACUMEN H, KAYABUTYL H-70, PERKADOX BC-FF, KAYAHEXA AD, PERKADOX 14, KAYABUTYL C, KAYABUTYL D, KAYAHEXA YD-E85, PERKADOX 12-XL25, PERKADOX 12-EB20, TRIGONOX 22-N70, TRIGONOX 22-70E, TRIGONOX D-T50, TRIGONOX 423-C70, KAYAESTER CND-C70, KAYAESTER CND-W50, TRIGONOX 23-C70, TRIGONOX 23-W50N, TRIGONOX 257-C70, KAYAESTER P-70, KAYAESTER TMPO-70, TRIGONOX 121, KAYAESTER O, KAYAESTER HTP-65 W, KAYAESTER AN, TRIGONOX 42, TRIGONOX F-C50, KAYABUTYL B, KAYACARBON EH-C70, KAYACARBON EH-W60, KAYACARBON 1-20, KAYACARBON BIC-75, TRIGONOX 117, and KAYALENE 6-70 (products up to here produced by Kayaku Akzo Corporation), LUPEROX LP (10-hour half-life temperature: 64° C.), LUPEROX 610 (10-hour half-life temperature: 37° C.), LUPEROX 188 (10-hour half-life temperature: 38° C.), LUPEROX 844 (10-hour half-life temperature: 44° C.), LUPEROX 259 (10-hour half-life temperature: 46° C.), LUPEROX 10 (10-hour half-life temperature: 48° C.), LUPEROX 701 (10-hour half-life temperature: 53° C.), LUPEROX 11 (10-hour half-life temperature: 58° C.), LUPEROX 26 (10-hour half-life temperature: 77° C.), LUPEROX 80 (10-hour half-life temperature: 82° C.), LUPEROX 7 (10-hour half-life temperature: 102° C.), LUPEROX 270 (10-hour half-life temperature: 102° C.), LUPEROX P (10-hour half-life temperature: 104° C.), LUPEROX 546 (10-hour half-life temperature: 46° C.), LUPEROX 554 (10-hour half-life temperature: 55° C.), LUPEROX 575 (10-hour half-life temperature: 75° C.), LUPEROX TANPO (10-hour half-life temperature: 96° C.), LUPEROX 555 (10-hour half-life temperature: 100° C.), LUPEROX 570 (10-hour half-life temperature: 96° C.), LUPEROX TAP (10-hour half-life temperature: 100° C.), LUPEROX TBIC (10-hour half-life temperature: 99° C.), LUPEROX TBEC (10-hour half-life temperature: 100° C.), LUPEROX JW (10-hour half-life temperature: 100° C.), LUPEROX TAIC (10-hour half-life temperature: 96° C.), LUPEROX TAEC (10-hour half-life temperature: 99° C.), LUPEROX DC (10-hour half-life temperature: 117° C.), LUPEROX 101 (10-hour half-life temperature: 120° C.), LUPEROX F (10-hour half-life temperature: 116° C.), LUPEROX DI (10-hour half-life temperature: 129° C.), LUPEROX 130 (10-hour half-life temperature: 131° C.), LUPEROX 220 (10-hour half-life temperature: 107° C.), LUPEROX 230 (10-hour half-life temperature: 109° C.), LUPEROX 233 (10-hour half-life temperature: 114° C.), and LUPEROX 531 (10-hour half-life temperature: 93° C.) (products up to here produced by ARKEMA Yoshitomi, Ltd.).

Examples of the photo-radical generator include aromatic ketones, acylphosphine oxide compounds, aromatic onium salts, organic peroxides, thio compounds (thioxanthone compounds, thiophenyl group-containing compounds, etc.), hexaarylbiimidazole compounds, ketoxime ester compounds, borate compounds, azinium compounds, metallocene compounds, active ester compounds, carbon-halogen-bond-containing compounds, and alkyl amine compounds.

Specific examples of the photo-radical generator include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholinopropan-1-one, bis(2,4,6-trimethylbenzoyl)phenylphosphine oxide, 2,4,6-trimethylbenzoyl diphenylphosphine oxide, 2,4-diethylthioxanthone, and bis-(2,6-dimethoxybenzoyl)-2,4,4-trimethylpentylphosphine oxide.

The method for forming the cured film may be any as long as a cured film is obtained from a composition containing an amine compound having six or more crosslinkable groups. The cured film may contain the amine compound having crosslinkable groups in an unreacted state.

From the viewpoints of the availability of the amine compound having crosslinkable groups, solvent resistance, film-forming properties, and charge injection properties, the cured film may be a layer that has hole-transporting ability.

The cured film is obtained by curing the composition containing an amine compound having crosslinkable groups by applying energy, such as heat, light, an electron beam, or the like.

In curing, the composition containing an amine compound having crosslinkable groups may be used with a thermal radical generator or a photo-radical generator depending on the energy used, so that the curability is enhanced and a cured film with excellent mechanical strength is obtained.

In order to strike a balance among properties such as electric properties and mechanical strength of the cured film, thermal curing may be performed to obtain a cured film.

The amount of the thermal radical generator used may be appropriately determined according to the amount of the amine compound having crosslinkable groups.

The amount of the thermal radical generator used in the composition containing an amine compound having crosslinkable groups is, for example, 0.1 parts by mass or more and 25 parts by mass or less, 1 part by mass or more and 20 parts by mass or less, or 5 parts by mass or more and 18 parts by mass or less relative to a total solid content of 100 parts by mass in the composition that contains an amine compound having crosslinkable groups.

The amount of the photo-radical generator used may be appropriately determined according to the amount of the amine compound having crosslinkable groups.

The amount of the thermal radical generator used in the composition containing an amine compound having crosslinkable groups is, for example, 0.001 parts by mass or more and 10 parts by mass or less, 0.01 part by mass or more and 5 parts by mass or less, or 0.1 parts by mass or more and 3 parts by mass or less relative to a total solid content of 100 parts by mass in the composition that contains an amine compound having crosslinkable groups.

### Organic Electroluminescent Device

The organic electroluminescent device is a device configured from a pair of electrodes, at least one of which is transparent, and at least one organic compound layer that includes a light-emitting layer, the organic compound layer being sandwiched between the electrodes.

In the organic electroluminescent device of this exemplary embodiment, at least one of the organic compound layers is the above-described cured film obtained from a composition that contains an amine compound having six or more crosslinkable groups (hereinafter this film may be referred to as a “specific cured film”).

In the organic electroluminescent device of this exemplary embodiment, when there is one organic compound layer, this organic compound layer is the emission layer that has hole-transporting ability, and this emission layer that has hole-transporting ability is the specific cured film of this exemplary embodiment.

In the organic electroluminescent device, when there are two or more organic compound layers (in other words, when the device is of a function-separated type with respective layers having different functions), at least one of the organic compound layers is the emission layer. Examples of the layer structure are the following layer structures (1) to (3). In the layer structures (1) to (3), at least one layer is the specific cured film described above in the organic electroluminescent device of this exemplary embodiment.

Layer structure (1): A function-separated type layer structure including a hole-transporting layer and an emission layer. In this structure, at least one of the hole-transporting layer and the emission layer may be the specific cured film, and the hole-transporting layer may be the specific cured film.
Layer structure (2): A function-separated type layer structure including a hole-transporting layer, an emission layer, and an electron-transporting layer. In this structure, at least one of the hole-transporting layer, the emission layer, and the electron-transporting layer may be the specific cured film, and the hole-transporting layer may be the specific cured film.
Layer structure (3): A function-separated type layer structure including an emission layer and an electron-transporting layer. In this structure, at least one of the emission layer and the electron-transporting layer may be the specific cured film, and the emission layer may be the specific cured film.

The organic electroluminescent devices of the exemplary embodiments will now be described with reference to the drawings, but these exemplary embodiments are not limiting.

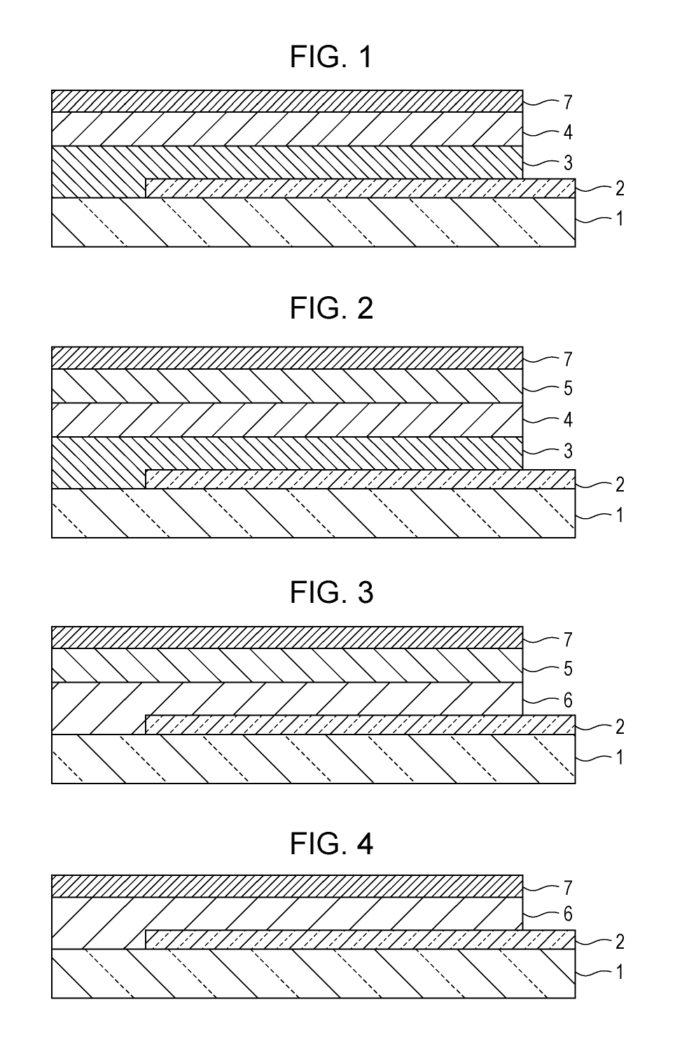

FIGS. 1 to 4 are schematic cross-sectional views illustrating the layer structures of organic electroluminescent devices of the exemplary embodiments. FIGS. 1, 2, and 3 illustrate examples in which there are more than one organic compound layer, and FIG. 4 illustrates an example in which there is one organic compound layer. In FIGS. 1 to 4, the layers having similar functions are represented by the same reference signs.

FIG. 1 illustrates the layer structure (1) described above.

The organic electroluminescent device illustrated in FIG. 1 is a device in which a transparent electrode 2, a hole-transporting layer 3, an emission layer 4, and a rear electrode 7 are stacked in this order on a transparent insulator substrate 1. A hole-injecting layer may be disposed between the transparent electrode 2 and the hole-transporting layer 3. In the exemplary embodiment illustrated in FIG. 1, the hole-transporting layer 3 may be the specific cured film of this exemplary embodiment. When there is a hole-injecting layer, this hole-injecting layer may be the specific cured film of this exemplary embodiment.

FIG. 2 illustrates the layer structure (2) described above.

The organic electroluminescent device illustrated in FIG. 2 is a device in which a transparent electrode 2, a hole-transporting layer 3, an emission layer 4, an electron-transporting layer 5, and a rear electrode 7 are stacked in this order on a transparent insulator substrate 1. A hole-injecting layer may be disposed between the transparent electrode 2 and the hole-transporting layer 3. An electron-injecting layer may be disposed between the electron-transporting layer 5 and the rear electrode 7. In the exemplary embodiment illustrated in FIG. 2, the hole-transporting layer 3 may be the specific cured film of this exemplary embodiment. When there is a hole-injecting layer, this hole-injecting layer may be the specific cured film of this exemplary embodiment.

FIG. 3 illustrates the layer structure (3) described above.

The organic electroluminescent device illustrated in FIG. 3 is a device in which a transparent electrode 2, an emission layer 6, an electron-transporting layer 5, and a rear electrode 7 are stacked in this order on a transparent insulator substrate 1. An electron-injecting layer may be disposed between the electron-transporting layer 5 and the rear electrode 7. In the exemplary embodiment illustrated in FIG. 3, the emission layer 6 may be the specific cured film of this exemplary embodiment. In such a case, the specific cured film of this exemplary embodiment contains at least one light-emitting material.

FIG. 4 illustrates the single-layer-type layer structure. The organic electroluminescent device illustrated in FIG. 4 is a device in which a transparent electrode 2, an emission layer 6 having hole-transporting ability, and a rear electrode 7 are stacked in this order on a transparent insulator substrate 1. In the exemplary embodiment illustrated in FIG. 4, the emission layer 6 is the specific cured film of this exemplary embodiment. In such a case, the specific cured film of this exemplary embodiment contains at least one light-emitting material.

In the organic electroluminescent devices illustrated in FIGS. 1 to 4, a protective layer may be formed on the rear electrode 7 to prevent deterioration of the organic electroluminescent devices by moisture and oxygen.

In a top emission structure or when two electrodes are both transparent electrodes, it is possible to employ a multilevel structure in which a plurality of the layer structures illustrated in FIGS. 1 to 4 are stacked.

The individual layers illustrated in FIGS. 1 to 4 will now be described in further detail.

Regarding the transparent insulator substrate 1, “transparent” means that the transmittance for light in the visible region is 10% or more. The transmittance may be 75% or more.

Examples of the transparent insulator substrate 1 include a glass plate, a quartz plate, a metal foil, and a resin film. Examples of the material for the resin film include methacrylic resins such as polymethyl methacrylate (PMMA), polyester resins, such as polyethylene terephthalate (PET) and polyethylene naphthalate (PEN), and polycarbonate resins.

The transparent insulator substrate 1 may be surface-treated or may have a multilayer structure to suppress water and gas penetration.

The transparent electrode 2 is transparent so as to allow light extraction as with the transparent insulator substrate 1, and an electrode having a large work function may be used as the transparent electrode 2 in order to inject holes. For example, an electrode having a work function of 4 eV or more may be used.

Regarding the transparent electrode 2, “transparent” means that the transmittance for light in the visible region is 10% or more. The transmittance may be 75% or more.

Examples of the material for the transparent electrode 2 include metal oxides such as indium tin oxide (ITO), tin oxide, indium oxide, zinc oxide, and indium zinc oxide; metals such as aluminum, nickel, gold, silver, platinum, and palladium; halogenated metals such as copper iodide; carbon black and conductive polymers such as poly(3-methylthiophene), polypyrrole, and polyaniline.

The sheet resistance of the transparent electrode 2 may be low, may be several hundred Ω/□ or less, or may be 100Ω/□ or less.

The organic compound layers (the layers denoted by reference numerals 3 to 6 in FIGS. 1 to 4) each contain a material selected from a hole-transporting material, a hole-injecting material, an electron-transporting material, an electron-injecting material, and a light-emitting material depending on the function.

When the organic compound layer is the specific cured film of this exemplary embodiment, the layer may be formed by using a composition that contains, along with any of the above-mentioned materials, a hole-transporting compound having crosslinkable groups and an electron-transporting compound having crosslinkable groups.

Examples of the hole-transporting material include tetraphenylenediamine derivatives, triphenylamine derivatives, carbazole derivatives, stilbene derivatives, arylhydrazone derivatives, porphyrin compounds, and spirofluorene derivatives.

Examples of the hole-injecting material include phenylenediamine derivatives, phthalocyanine derivatives, indanthrene derivatives, and polyalkylenedioxythiophene derivatives. These may be mixed with an organic acid such as a Lewis acid or sulfonic acid, or an inorganic acid such as iron chloride.

Examples of the electron-transporting material include oxadiazole derivatives, nitro-substituted fluorenone derivatives, diphenoquinone derivatives, thiopyran dioxide derivatives, silole derivatives, chelate-type organometal complexes, polynuclear or condensed aromatic ring compounds, perylene derivatives, triazole derivatives, and fluorenylidenemethane derivatives.

Examples of the electron-injecting material include metals such as Li, Ca, and Sr, metal fluorides such as LiF and MgF, and metal oxides such as MgO, Al₂O₃, and LiO.

The light-emitting material may be a compound having a high emission quantum efficiency in a solid state. The light-emitting material may be a low-molecular-weight compound or a high-molecular-weight compound.

Examples of the low-molecular-weight organic compound include chelate-type organometal complexes, polynuclear or condensed aromatic ring compounds, perylene derivatives, coumarin derivatives, styrylarylene derivatives, silole derivatives, oxazole derivatives, oxathiazole derivatives, and oxadiazole derivatives.

Examples of the high-molecular-weight organic compound include polyparaphenylene derivatives, polyparaphenylene vinylene derivatives, polythiophene derivatives, and polyacetylene derivatives.

Specific examples of the light-emitting material include example compounds (VI-1) to (VI-17) below.

Example compounds (VI-1) to (VI-17) below can also be used as electron-transporting materials.

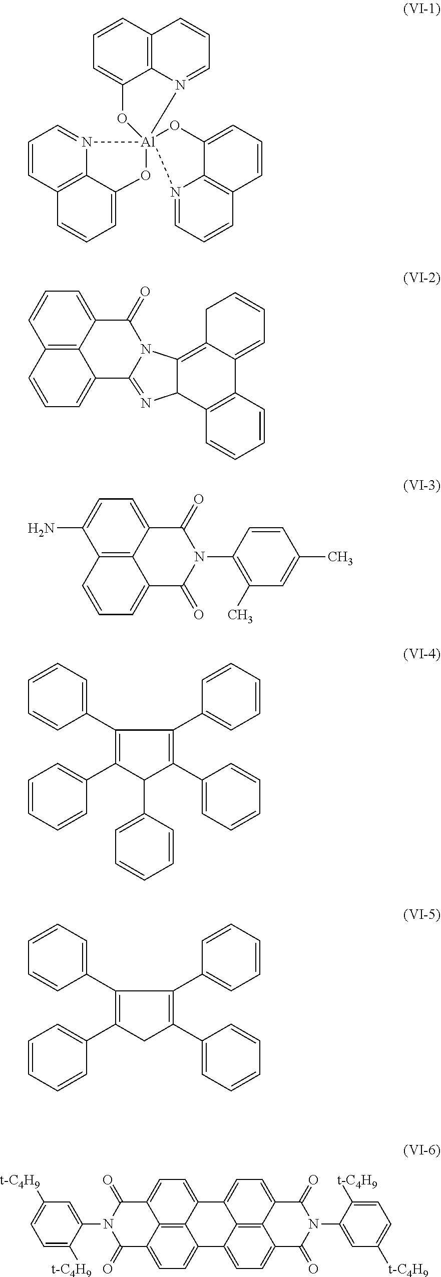

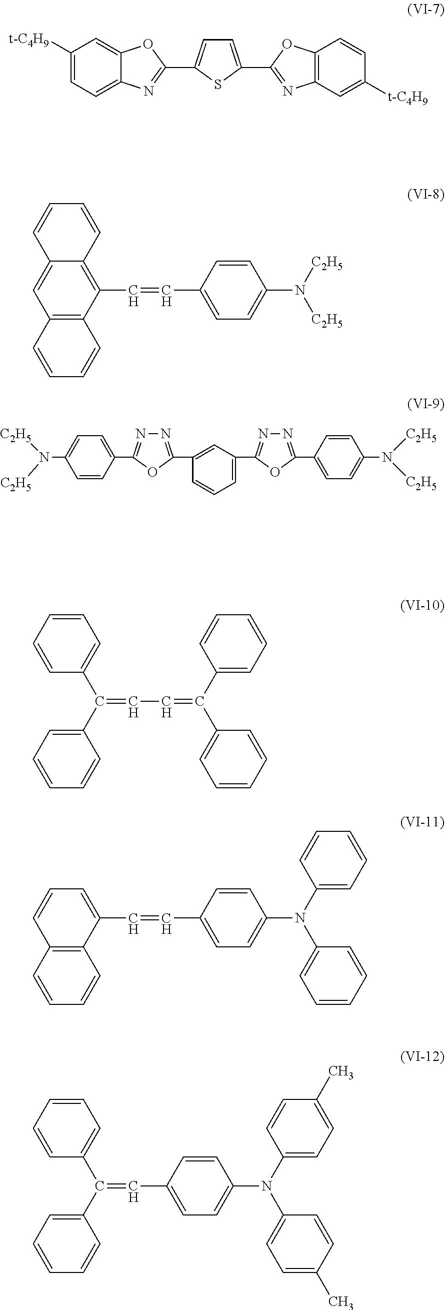

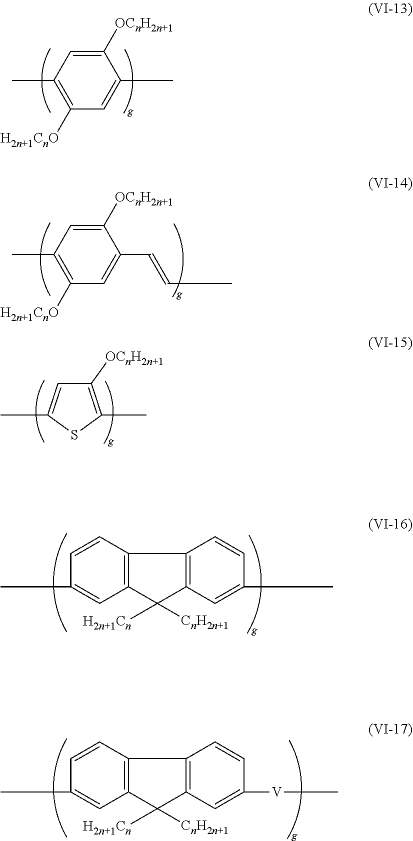

In example compounds (VI-13) to (VI-17), n and g each independently represent an integer of 1 or more, and V represents a divalent linking group. Examples of V include the following divalent groups.

In the divalent groups described below, g represents an integer of 1 or more, and h represents an integer of 0 or more and 5 or less.

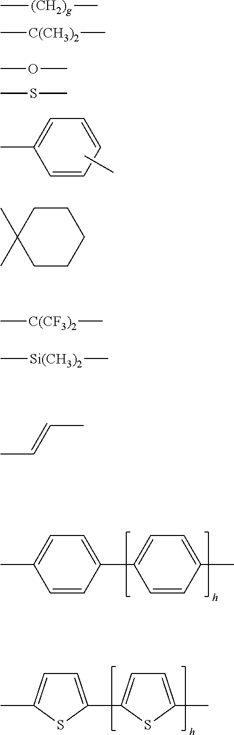

In order to improve the durability of the organic electroluminescent device or improve the emission efficiency, the light-emitting material may be doped with a guest material, that is, a coloring compound different from the light-emitting material.

The amount of the coloring compound doped relative to 100 parts by mass of the host may be 0.001 parts by mass or more and 40 parts by mass or less, or 0.01 parts by mass or more and 10 parts by mass or less.

Examples of the coloring compound used as a dopant include coumarin derivatives, DCM derivatives, quinacridone derivatives, perimidone derivatives, benzopyran derivatives, rhodamine derivatives, benzothioxanthene derivatives, rubrene derivatives, and porphyrin derivatives; and complex compounds of metals such as ruthenium, rhodium, palladium, silver, rhenium, osmium, iridium, platinum, and gold.

Specific examples of the coloring compound used as a dopant include example compounds (VII-1) to (VII-6) below.

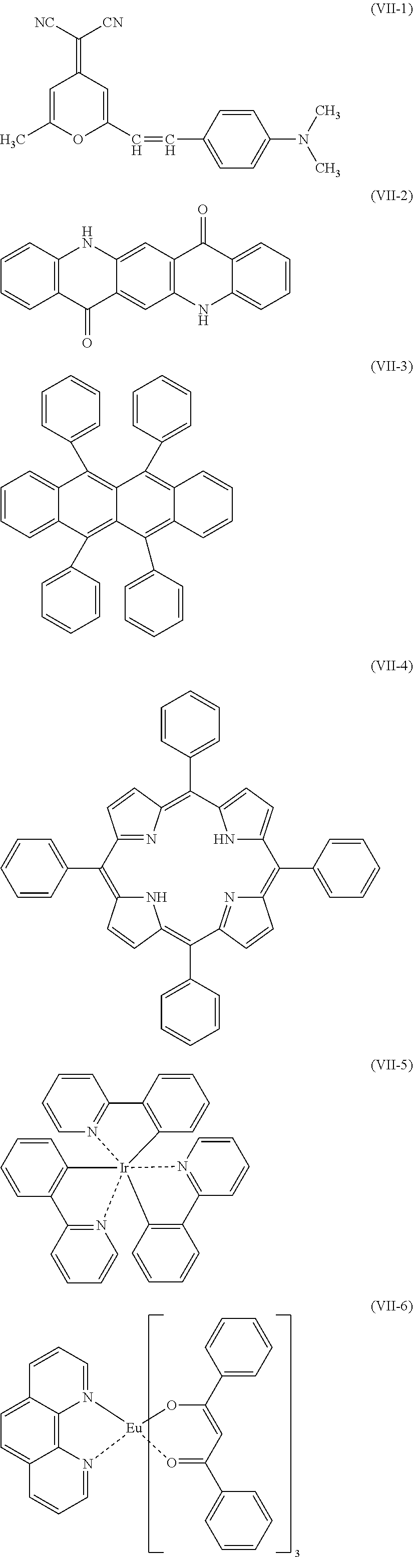

The organic compound layers may contain a binder resin.

Examples of the binder resin include electrically conductive resins such as polycarbonate resins, polyester resins, methacrylic resins, acrylic resins, polyvinyl chloride resins, cellulose resins, urethane resins, epoxy resins, polystyrene resins, polyvinyl acetate resins, styrene-butadiene copolymers, vinylidene chloride-acrylonitrile copolymers, vinyl chloride-vinyl acetate-maleic anhydride copolymers, silicone resins, poly-N-vinylcarbazole resins, polysilane resins, polythiophene, and polypyrrole.

If needed, the organic compound layers may contain an antioxidant, a UV absorber, a plasticizer, etc., known in the art.

The material for the rear electrode 7 may be a material that can be vacuum vapor deposited and has a small work function for electron injection. Examples of the material include metals, metal oxides, and metal fluorides.

Examples of the metal include magnesium, aluminum, gold, silver, indium, lithium, calcium, and alloys thereof.

Examples of the metal oxide include lithium oxide, magnesium oxide, aluminum oxide, indium tin oxide, tin oxide, indium oxide, zinc oxide, and indium zinc oxide.

Examples of the metal fluoride include lithium fluoride, magnesium fluoride, strontium fluoride, calcium fluoride, and aluminum fluoride.

A protective layer may be disposed on the rear electrode 7.

Examples of the material for the protective layer include metals such as indium, tin, lead, gold, silver, copper, and aluminum; metal oxides such as magnesium oxide, silicon dioxide, and titanium oxide; and resins such as polyethylene resins, polyurea resins, and polyimide resins.

In general, the transparent electrode 2, the organic compound layers, the rear electrode 7, and the protective layer may each have a thickness of 0.001 μm or more and 10 μm or less, or 0.001 μm or more and 5 μm or less.

The organic electroluminescent devices illustrated in FIGS. 1 to 4 are produced by sequentially forming a transparent electrode 2, organic compound layers, and a rear electrode 7 on a transparent insulator substrate 1.

The transparent electrode 2, the organic compound layers, and the rear electrode 7 can be formed by, for example, a vacuum vapor deposition method, a sputtering method, or a coating method.

The coating method is a film-forming method that involves applying a coating solution, prepared by dissolving or dispersing the materials in an appropriate solvent, to the transparent electrode 2, and drying the applied film.

Examples of the method for applying the coating solution include a spin coating method, a die coating method, an ink jet method, a casting method, and a dipping method.

The state in which the materials in the organic compound layer are contained may be a state in which molecules are dispersed (molecule dispersed state) or a state in which molecules form particles and are dispersed (particle dispersed state).

In order to create the molecule dispersed state by the film-forming method that uses a coating solution, the solvent of the coating solution is selected by considering the dispersibility and dissolvability of each material.

In order to create the particle dispersed state by the film-forming method that uses a coating solution, the coating solution is prepared by using any one of a ball mill, a sand mill, a paint shaker, an attritor, a homogenizer, and ultrasonic waves.

Organic electroluminescent devices of the exemplary embodiment are arranged to form a matrix or a segment so as to constitute an image displaying medium.

When the organic electroluminescent devices are arranged to form a matrix, only the electrodes may be arranged to form a matrix, or the organic compound layers as well as the electrodes may be arranged to form a matrix.

When the organic electroluminescent devices are arranged to form a segment, only the electrodes may be arranged to form a segment, or the organic compound layers as well as the electrodes may be arranged to form a segment.

The organic compound layers forming a matrix or a segment can be formed by an ink jet method.

Examples of a driving device and a driving method for a matrix of organic electroluminescent devices or a segment of organic electroluminescent devices include those described in Japanese Laid Open Patent Application Publication Nos. 2-148687, 6-301355, 5-29080, 7-134558, 8-234685, and 8-241047, Japanese Patent No. 2784615, U.S. Pat. Nos. 5,828,429, and 6,023,308.

### EXAMPLES

The present disclosure will now be described in further detail through examples, which do not limit the present disclosure. Unless otherwise noted, “parts” means “parts by mass”.

### Synthesis of Amine Compound Having Six or More Crosslinkable Groups

### Synthetic Example 1: Synthesis of CTM-1

CTM-1 indicated in Table 4 is synthesized by the following scheme.

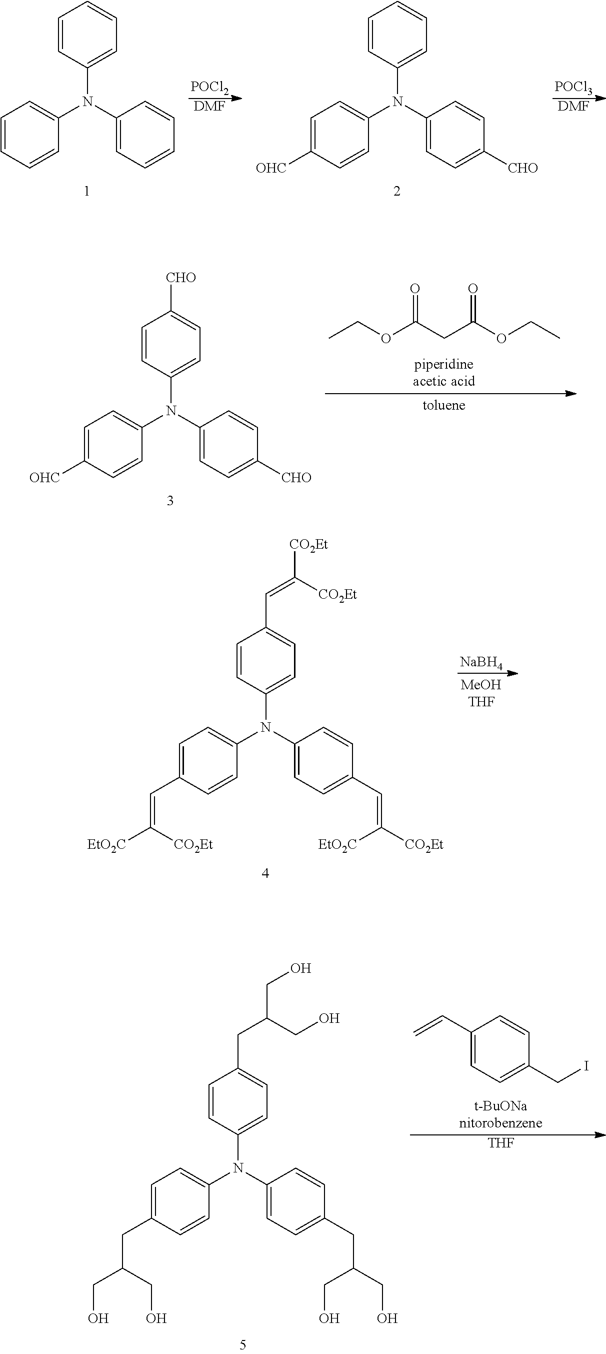

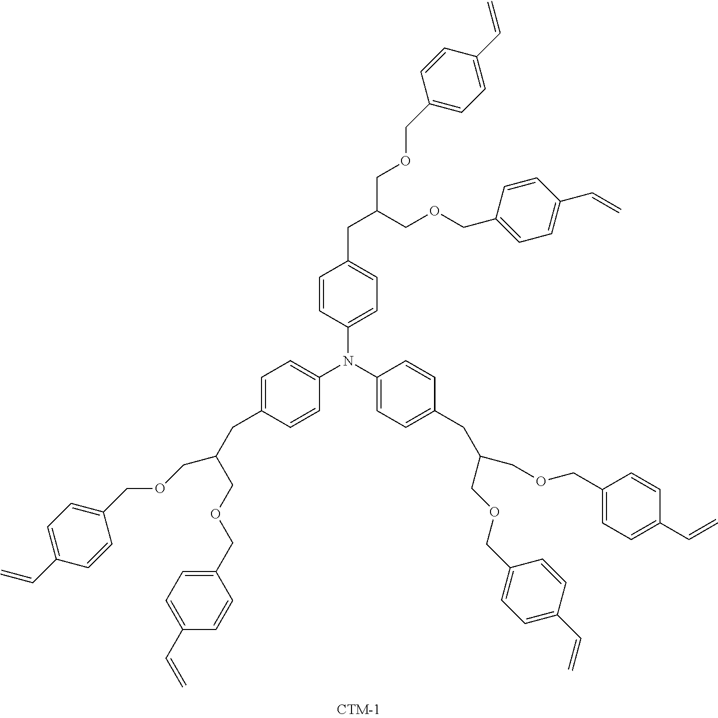 [SMILES: C=Cc1ccc(COCC(COCc2ccc(C=C)cc2)Cc2ccc(N(c3ccc(CC(COCc4ccc(C=C)cc4)COCc4ccc(C=C)cc4)cc3)c3ccc(CC(COCc4ccc(C=C)cc4)COCc4ccc(C=C)cc4)cc3)cc2)cc1]

Into a three-necked flask, 100 g of compound 1 and 408 ml of dimethylformamide are added. After the compound 1 is dissolved, the resulting solution is cooled to 0° C., and 380 ml of phosphorus oxychloride is added dropwise thereto over 1 hour under stirring. Upon completion of the dropwise addition, stirring is conducted at a temperature of 105° C. for 48 hours. The resulting mixture is cooled to room temperature, and distilled water is added thereto to precipitate crystals. After drying, purification by column chromatography (adsorbent: silica gel, solvent: toluene) is conducted, and then recrystallization is conducted. As a result, 42.0 g of a solid compound 2 is obtained.

Into a three-necked flask, 42.0 g of compound 2 and 140 ml of dimethylformamide are added. After the compound 2 is dissolved, the resulting solution is cooled to 0° C., and 130 ml of phosphorus oxychloride is added dropwise thereto over 1 hour under stirring. Upon completion of the dropwise addition, stirring is conducted at a temperature of 80° C. for 120 hours. The resulting mixture is cooled to room temperature, and distilled water is added thereto to precipitate crystals. After drying, purification by column chromatography (adsorbent: silica gel, solvent: toluene) is conducted, and then recrystallization is conducted. As a result, 9.84 g of a solid compound 3 is obtained.

Into a three-necked flask, 9.00 g of compound 3, 232 ml of toluene, and 18.4 ml of diethyl malonate are added to dissolve the compound 3. To the resulting solution, 1.62 ml of piperidine and 0.94 ml of acetic acid are added, followed by stirring at 110° C. for 4 hours. To the resulting solution, 1.62 ml of piperidine and 0.94 ml of acetic acid are added, followed by stirring at 110° C. for 4 hours. Then, the resulting mixture is cooled to room temperature, 300 ml of ethyl acetate is added, the organic layer is washed three times with 250 ml distilled water, the washed organic layer is dried over sodium sulfate anhydrous, and the solvent is distilled away under a reduced pressure. Then purification by column chromatography (adsorbent: silica gel, solvent: toluene) is conducted, and, as a result, 13.2 g of a solid compound 4 is obtained.

Into a round-bottomed flask, 12.0 g of the solid compound 4 is added and dissolved in 160 ml of tetrahydrofuran. The resulting solution is cooled to 0° C., 8.9 g of sodium borohydride is added thereto, 20 ml of methanol/tetrahydrofuran=(1/1) is added thereto dropwise, and the resulting mixture is stirred at room temperature for 72 hours. To the mixture, 300 ml of ethyl acetate is added, followed by stirring for 20 hours. Then, acetic acid is added until the pH value is 5, washing is conducted three times with 200 ml of distilled water, drying is conducted over sodium sulfate anhydrous, and the solvent is distilled away under a reduced pressure. As a result, 6.0 g of an oily compound 5 is obtained.

Into a three-necked flask, 4.10 g of the oily compound 5 is added and dissolved in 60 ml of tetrahydrofuran. Thereto, 0.1 g of nitrobenzene, 18 g of 4-iodomethylstyrene, and 5.6 g of sodium tert-butoxide are gradually added, followed by stirring at 0° C. for 48 hours. Then, the resulting mixture is cooled to room temperature, 150 ml of cyclohexane is added, 2 N hydrochloric acid is added until the pH value is 5, the organic layer is washed three times with 200 ml distilled water, the washed organic layer is dried over sodium sulfate anhydrous, and the solvent is distilled away under a reduced pressure. Then purification by column chromatography (adsorbent: silica gel, solvent: cyclohexane/toluene/ethyl acetate=7/3/0.5) is conducted, and, as a result, 4.0 g of oily CTM-1 is obtained.

### Synthetic Example 2: Synthesis of CTM-29

CTM-29 indicated in Table 4 is synthesized by the following scheme.

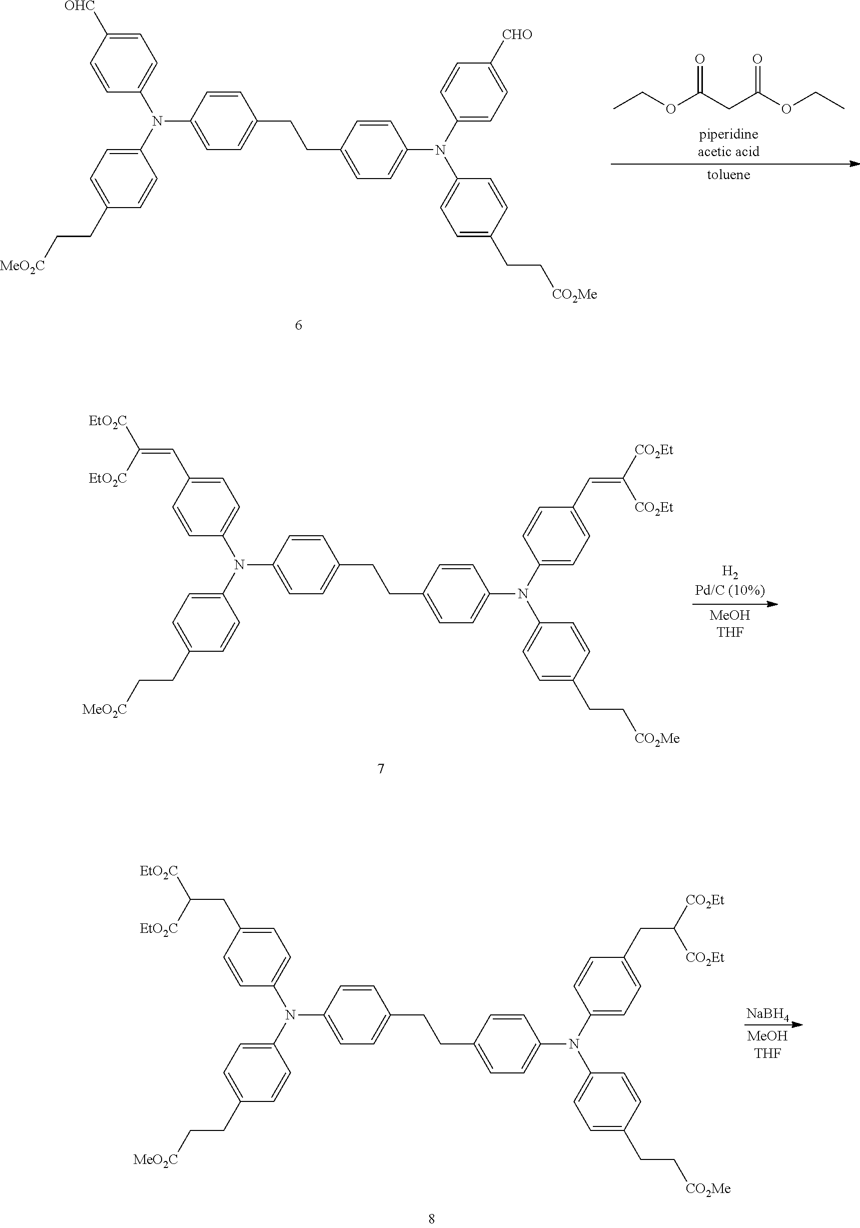 [SMILES: COC(=O)CCc1ccc(N(c2ccc(C=O)cc2)c2ccc(CCc3ccc(N(c4ccc(C=O)cc4)c4ccc(CCC(=O)OC)cc4)cc3)cc2)cc1 ; CCOC(=O)CC(=O)OCC ; CCOC(=O)C(=Cc1ccc(N(c2ccc(CCC(=O)OC)cc2)c2ccc(CCc3ccc(N(c4ccc(C=C(C(=O)OCC)C(=O)OCC)cc4)c4ccc(CCC(=O)OC)cc4)cc3)cc2)cc1)C(=O)OCC ; CCOC(=O)C(Cc1ccc(N(c2ccc(CCC(=O)OC)cc2)c2ccc(CCc3ccc(N(c4ccc(CCC(=O)OC)cc4)c4ccc(CC(C(=O)OCC)C(=O)OCC)cc4)cc3)cc2)cc1)C(=O)OCC ; "NaBH4"]

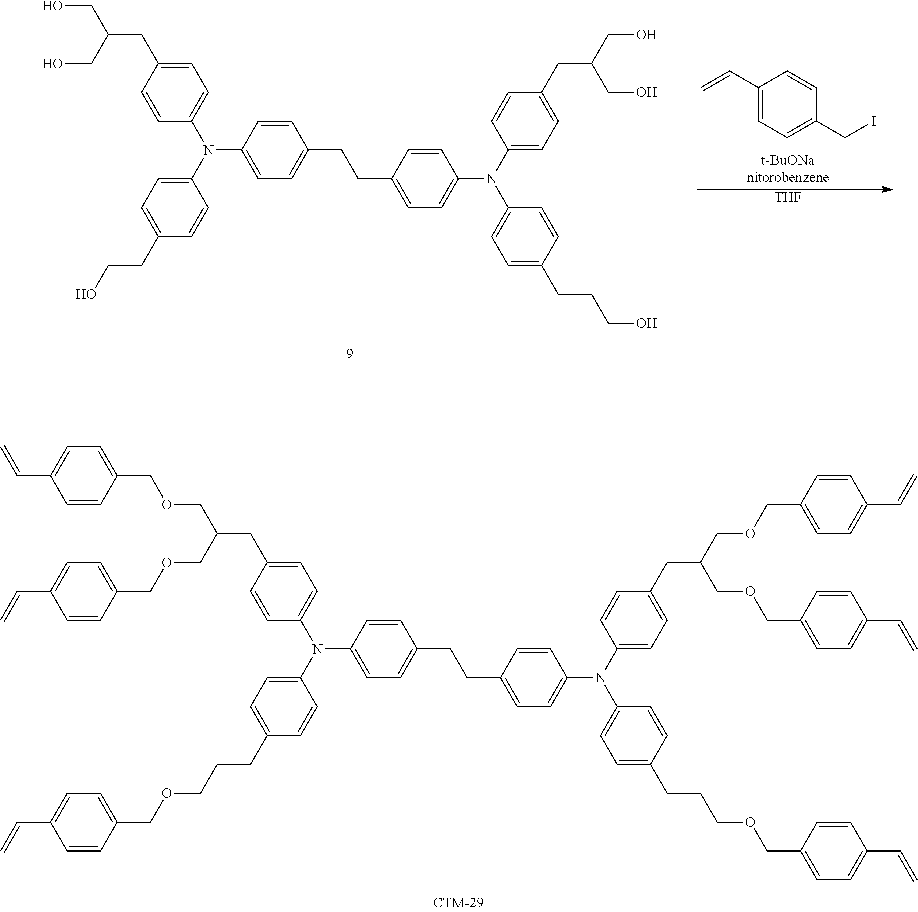

Into a three-necked flask, 30 g of compound 6, 220 ml of toluene, and 30.0 ml of diethyl malonate are added to dissolve the compound 6. To the resulting solution, 1.8 ml of piperidine and 2.3 ml of acetic acid are added, followed by stirring at 130° C. for 5 hours. To the resulting solution, 1.8 ml of piperidine and 2.3 ml of acetic acid are added, followed by stirring at 120° C. for 20 hours. Then, the resulting mixture is cooled to room temperature, 250 ml of ethyl acetate is added, the organic layer is washed three times with 250 ml distilled water, the washed organic layer is dried over sodium sulfate anhydrous, and the solvent is distilled away under a reduced pressure. Then purification by column chromatography (adsorbent: silica gel, solvent: toluene) is conducted, and, as a result, 25.5 g of a solid compound 7 is obtained.

Into a round-bottomed flask, 25.5 g of the oily compound 7 is added and dissolved in 100 ml of tetrahydrofuran. Thereto, 150 ml of methanol, and 2 g of 10% Pd/C is added, the resulting mixture is stirred for 24 hours while being connected to a hydrogen gas supply source, and the solvent is distilled away under a reduced pressure. Then purification by column chromatography (adsorbent: silica gel, solvent: toluene) is conducted, and, as a result, 22.3 g of an oily compound 8 is obtained.

Next, into a three-necked flask, 19.5 g of the oily compound 8 is added and dissolved in 130 ml of tetrahydrofuran. The resulting solution is cooled to 0° C., 12.9 g of sodium borohydride is added thereto, 20 ml of methanol/tetrahydrofuran=1/1 is added thereto dropwise, and the resulting mixture is stirred at room temperature for 72 hours. Then, 40 ml of ethyl acetate is added, followed by stirring for 20 hours. After acetic acid is added until the pH value is 5, washing is conducted three times with 200 ml distilled water, drying is conducted over sodium sulfate anhydrous, and the solvent is distilled away under a reduced pressure. As a result, 9.0 g of an oily compound 9 is obtained.

Into a three-necked flask, 6.10 g of the oily compound 9 is added and dissolved in 40 ml of tetrahydrofuran. Thereto, 0.1 ml of nitrobenzene, 18 g of 4-iodomethylstyrene, and 5.6 g of sodium tert-butoxide are gradually added, followed by stirring at 0° C. for 40 hours. Then, the resulting mixture is cooled to room temperature, 100 ml of cyclohexane is added, 2 N hydrochloric acid is added until the pH value is 5, the organic layer is washed three times with 200 ml distilled water, the washed organic layer is dried over sodium sulfate anhydrous, and the solvent is distilled away under a reduced pressure. Then purification by column chromatography (adsorbent: silica gel, solvent: toluene/ethyl acetate=20/1) is conducted, and, as a result, 7.8 g of oily CTM-29 is obtained.

### Preparation of Organic Electroluminescent Device

### Example 1

ITO (produced by GEOMATEC Co., Ltd.) formed on a glass substrate is subjected to photolithographic patterning through a strip-shaped photomask, and etched to form a strip-shaped ITO electrode (width: 2 mm). Next, the ITO glass substrate is washed by sequentially immersing the ITO glass substrate in a neutral detergent, water, acetone (for electronic engineering use, produced by Kanto Chemical Co., Inc.), and isopropanol (for electronic engineering use, produced by Kanto Chemical Co., Inc.) in that order, while applying ultrasonic waves for 5 minutes in each liquid. The washed ITO glass substrate is then dried by using a spin coater.

In 77 parts by mass of toluene, 3 parts by mass of CTM-29, which is the amine compound having six or more crosslinkable groups, is dissolved, and then 0.5 parts by mass of a thermal radical generator, V-601, is further dissolved therein. The resulting solution is filtered through a PTFE filter with a pore diameter of 0.1 μm so as to obtain a coating solution. The coating solution is applied to the ITO glass substrate by a dipping method, and a film is formed in a glove box with an oxygen concentration of 200 ppm or less at a temperature of 145° C. for 35 minutes. As a result, a hole-transporting layer having a thickness of about 0.03 μm is obtained.

Example compound (VI-1), serving as a light-emitting material, is vapor-deposited on the hole-transporting layer so as to form an emission layer having a thickness of 0.055 μm.

A metal mask having a strip-shaped hole is placed on the emission layer, and Mg—Ag-alloy is co-vapor-deposited so as to form a rear electrode 2 mm in width and 0.15 μm in thickness intersecting the ITO electrode. The effective area of the organic electroluminescent device obtained is 0.04 cm².

### Examples 2 to 8

Organic electroluminescent devices of Examples 2 to 8 are prepared as in Example 1 except that the CTM-29, which is the amine compound having six or more crosslinkable groups in Example 1, is changed to other amine compounds having six or more crosslinkable groups, CTM-1, CTM-16, CTM-5, CTM-10, CTM-17, CTM-28, and CTM-36.

### Comparative Examples 1 to 3

Organic electroluminescent devices of Comparative Examples 1 to 3 are prepared as in Example 1 except that the CTM-29, which is the amine compound having six or more crosslinkable groups in Example 1, is changed to compound 10, compound 11, and compound 12.

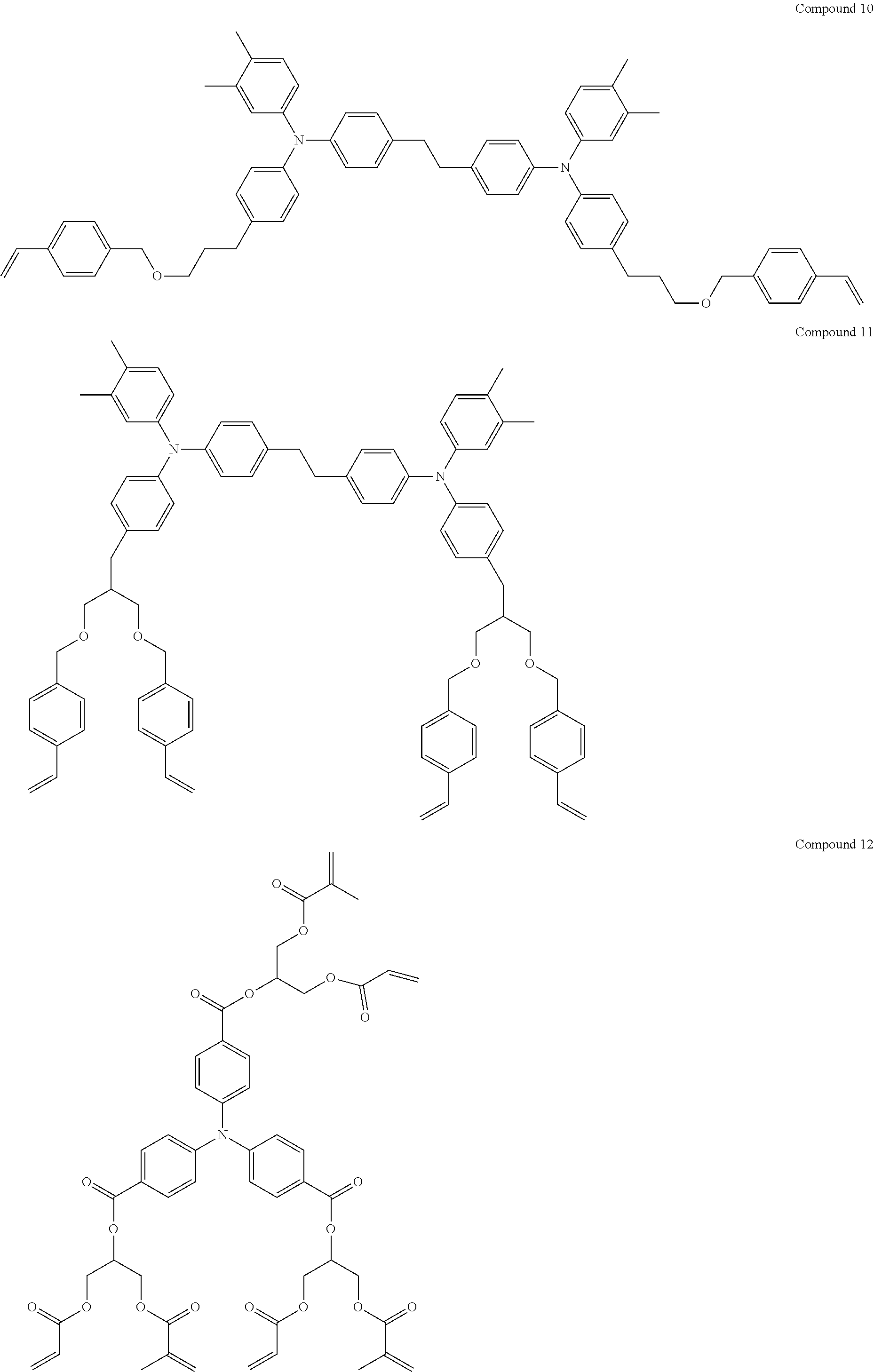 [SMILES: C=Cc1ccc(COCCCc2ccc(N(c3ccc(CCc4ccc(N(c5ccc(CCCOCc6ccc(C=C)cc6)cc5)c5ccc(C)c(C)c5)cc4)cc3)c3ccc(C)c(C)c3)cc2)cc1 ; C=Cc1ccc(COCC(COCc2ccc(C=C)cc2)Cc2ccc(N(c3ccc(CCc4ccc(N(c5ccc(CC(COCc6ccc(C=C)cc6)COCc6ccc(C=C)cc6)cc5)c5ccc(C)c(C)c5)cc4)cc3)c3ccc(C)c(C)c3)cc2)cc1 ; C=CC(=O)OCC(COC(=O)C(=C)C)OC(=O)c1ccc(N(c2ccc(C(=O)OC(COC(=O)C=C)COC(=O)C(=C)C)cc2)c2ccc(C(=O)OC(COC(=O)C=C)COC(=O)C(=C)C)cc2)cc1]

### Evaluation of Lifetime

The emission properties of the organic electroluminescent devices of Examples and Comparative Examples prepared as described above are studied by applying a DC voltage to an ITO electrode at the plus side and the Al electrode at the minus side, and by measuring the drive current density at an initial luminance of 500 cd/m² by a DC drive method (DC drive). The lifetime is evaluated Through the relative time and the increase in voltage determined as follows. In dry air at room temperature (40% RH, 27° C.), a DC drive method (DC drive) is performed by setting the initial luminance to 500 cd/m², and the drive time (half-luminance time) taken for the luminance (initial luminance L0: 500 cd/m²) of the device of Comparative Example 1 to drop to luminance L/initial luminance L0=0.5 is assumed to be 1.0. The values of the half-luminance time of other devices are then determined as the relative time relative to Comparative Example 1. In addition, the increase in voltage (=voltage/initial drive voltage) at the time the luminance of the device reaches luminance L/initial luminance L0=0.5 is also determined. The results are indicated in Table 5.

### Evaluation of Surface Roughness

The cured films prepared under the conditions of Examples 1 to 8 and Comparative Examples 1 to 3 are analyzed to determine the surface roughness Ra, which is assumed to be A. The surface roughness Ra of the cured films after the treatment of placing toluene and leaving toluene thereon for 30 seconds is measured, and is assumed to be B. The surface roughness is measured with a stylus-type surface profiler, DEKTAK 6M (produced by ULVAC, Inc.). The rate of change in surface roughness is calculated by using formula, B/A×100.

The rate of change in surface roughness Ra before and after the treatment of placing toluene and leaving toluene thereon for 30 seconds is evaluated by the process described above. The results are indicated in Table 5.

### Evaluation of Volume Resistivity of Cured Film Layer

A film is formed on a gold electrode by the same method as in Examples described above, and cured to obtain a single-layer film. The gold electrode with the single-layer film thereon is immersed in a toluene solvent for 30 seconds, taken out, and blow-dried with nitrogen. A 100 nm-thick, 1 cm² gold electrode serving as a counter electrode is vacuum-sputtered onto the dried single-layer film so as to prepare a sample for measuring resistivity. By using SI 1287 Electrochemical Interface (produced by TOYO Corporation) as a power supply, SI 1260 Impedance/Gain Phase Analyzer (produced by TOYO Corporation) as an amperemeter, and 1296 dielectric interface (produced by TOYO Corporation) as a current amplifier, a 1 V AC voltage is applied from a high-frequency-side within a range of 1 MHz to 1 mHz to measure the AC impedance of each sample. The profile of the Cole-Cole plot obtained by this measurement is fitted into an R—C parallel equivalent circuit so as to obtain the volume resistivity (Ω·cm). The results are indicated in Table 5.

TABLE 5

| | | | | | | | | Evaluation of lifetime | |
|---|---|---|---|---|---|---|---|---|---|
| | | | | | | | | | Increase in |
| | Amine compound having | | Radical | | | | | Half- | voltage at |
| | crosslinkable groups | | generator | | | | Rate of | luminance | half- |
| | Hole- | Number of | content | Residual | Volume | Surface | change in | time | luminance |
| | transporting | crosslinkable | [parts by | film ratio | resistivity | roughness | surface | (relative | time (relative |
| Classification | compound | groups | mass]*¹ | [%]*² | [Ω · cm] | Ra [nm]*² | roughness*³ | value) | value) |
| Example 1 | CTM-29 | 6 | 12.3 | 99 | 9.7 × 10⁸ | 19 | 0.99 | 2.13 | 1.21 |
| Example 2 | CTM-1 | 6 | 13.5 | 99 | 9.2 × 10⁸ | 21 | 0.99 | 2.02 | 1.08 |
| Example 3 | CTM-16 | 8 | 11.2 | 99 | 8.8 × 10⁸ | 15 | 0.99 | 2.01 | 1.06 |
| Example 4 | CTM-5 | 6 | 11.8 | 99 | 6.4 × 10⁸ | 22 | 0.99 | 2.15 | 1.15 |
| Example 5 | CTM-10 | 6 | 10.7 | 99 | 8.3 × 10⁸ | 20 | 0.99 | 2.17 | 1.14 |
| Example 6 | CTM-17 | 6 | 8.9 | 99 | 8.4 × 10⁸ | 21 | 0.99 | 2.09 | 1.06 |
| Example 7 | CTM-28 | 8 | 9.5 | 99 | 8.8 × 10⁸ | 16 | 0.99 | 2.03 | 1.04 |
| Example 8 | CTM-36 | 8 | 8.3 | 99 | 9.7 × 10⁸ | 17 | 0.99 | 2.04 | 1.05 |
| Comparative | Compound 10 | 2 | 10.3 | 88 | 2.1 × 10¹⁶ | 85 | 0.83 | 0.98 | 1.41 |
| Example 1 | | | | | | | | | |
| Comparative | Compound 11 | 4 | 11.2 | 89 | 6.8 × 10¹⁶ | 80 | 0.85 | 1.03 | 1.51 |
| Example 2 | | | | | | | | | |
| Comparative | Compound 12 | 6 | 10.7 | 93 | 6.8 × 10¹² | 57 | 0.9 | 1.2 | 1.37 |
| Example 3 | | | | | | | | | |

*¹The amount of a thermal radical generator or photo-radical generator contained relative to a total solid content of 100 parts by mass in the composition.
*²Evaluation after the treatment of placing toluene on the film and leaving toluene thereon for 30 seconds.
*³Rate of change in surface roughness before and after the treatment of placing toluene on the film and leaving toluene thereon for 30 seconds.

As indicated in Table 5, the organic electroluminescent devices of Examples 1 to 8 equipped with a cured film obtained from a composition that contains an amine compound having six or more crosslinkable groups have a longer drive time until the luminance drops to a half and have a smaller increase in voltage at the half-luminance time compared to the organic electroluminescent devices of Comparative Examples 1 to 3 equipped with a cured film obtained from a composition that contains an amine compound having two or four crosslinkable groups. In other words, the organic electroluminescent devices of Examples 1 to 8 have longer lifetime than the organic electroluminescent devices of Comparative Examples 1 to 3.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An organic electroluminescent device comprising:
an anode and a cathode that are a pair of electrodes, at least one of the electrodes being transparent or translucent; and
an organic compound layer interposed between the electrodes, the organic compound layer including at least one layer containing a cured film obtained from a composition that contains an amine compound having six or more crosslinkable groups,
wherein the cured film has a residual film ratio of 90% or more after a condition described below, and a rate of change in surface roughness Ra of the cured film before and after the condition described below is 0.99 or more:
condition: placing toluene on the cured film and leaving toluene thereon for 30 seconds.

2. The organic electroluminescent device according to claim 1, wherein the surface roughness Ra of the cured film after the condition is 25 nm or less.

3. The organic electroluminescent device according to claim 1, wherein the crosslinkable groups in the amine compound contain a vinylphenyl group.

4. The organic electroluminescent device according to claim 3, wherein a functional group that contains the vinylphenyl group is a group that has at least one of groups represented by general formulae (A-1) and (A-2): 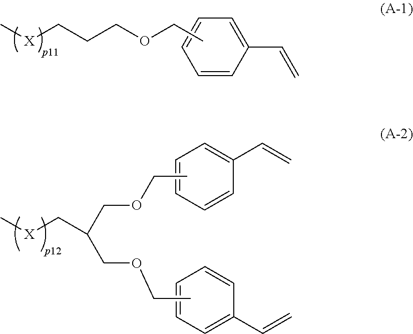
wherein, in (A-1) and (A-2), X each independently represent a divalent linking group formed of one or a combination of two or more selected from an alkylene group, —C═C—, —C(═O)—, —N(R)—, —O—, and —S—, R represents a hydrogen atom, an alkyl group, an aryl group, or an aralkyl group, and p11 and p12 each independently represent an integer of 0 or 1.

5. The organic electroluminescent device according to claim 4, wherein the amine compound is selected from the group consisting of compounds represented by general formulae (B-1), (B-2), and (B-3): 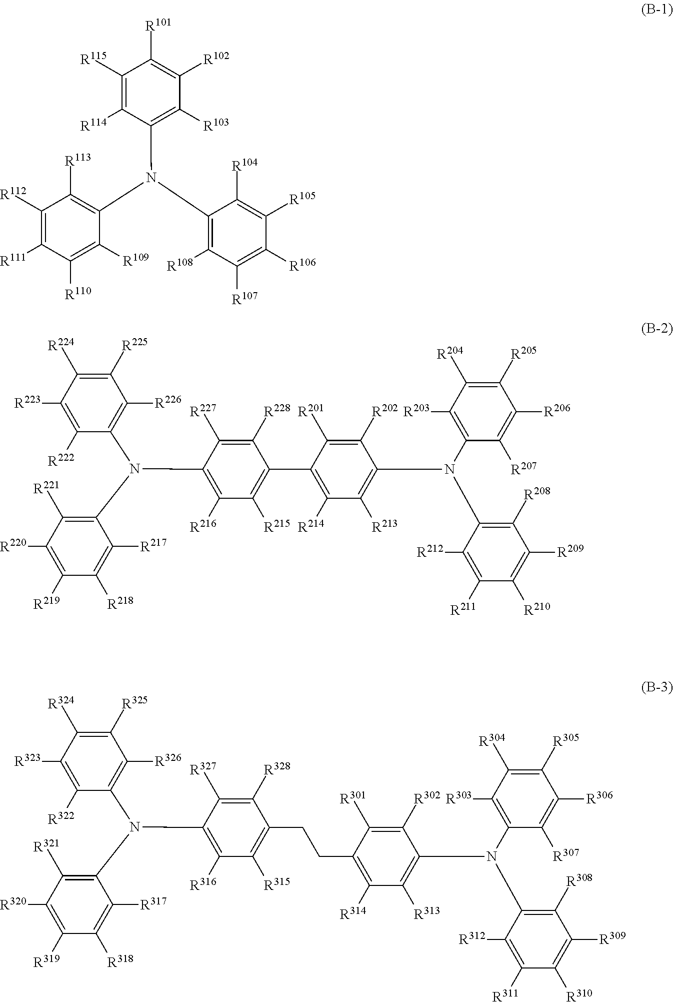
wherein:
R¹⁰¹, R¹⁰², R¹⁰³, R¹⁰⁴, R¹⁰⁵, R¹⁰⁶, R¹⁰⁷, R¹⁰⁸, R¹⁰⁹, R¹¹⁰, R¹¹¹, R¹¹², R¹¹³, R¹¹⁴, and R¹¹⁵ each independently represent a hydrogen atom, a halogen atom, an alkyl group, an alkoxy group, an aryl group, a group represented by general formula (A-1), or a group represented by general formula (A-2) provided that the number of the crosslinkable groups in the compound is six or more;
R²⁰¹, R²⁰², R²⁰³, R²⁰⁴, R²⁰⁵, R²⁰⁶, R²⁰⁷, R²⁰⁸, R²⁰⁹, R²¹⁰, R²¹¹, R²¹², R²¹³, R²¹⁴, R²¹⁵, R²¹⁶, R²¹⁷, R²¹⁸, R²¹⁹, R²²⁰, R²²¹, R²²², R²²³, R²²⁴, R²²⁵, R²²⁶, R²²⁷, and R²²⁸ each independently represent a hydrogen atom, a halogen atom, an alkyl group, an alkoxy group, an aryl group, a group represented by general formula (A-1), or a group represented by general formula (A-2) provided that the number of the crosslinkable groups in the compound is six or more; and
R³⁰¹, R³⁰², R³⁰³, R³⁰⁴, R³⁰⁵, R³⁰⁶, R³⁰⁷, R³⁰⁸, R³⁰⁹, R³¹⁰, R³¹¹, R³¹², R³¹³, R³¹⁴, R³¹⁵, R³¹⁶, R³¹⁷, R³¹⁸, R³¹⁹, R³²⁰, R³²¹, R³²², R³²³, R³²⁴, R³²⁵, R³²⁶, R³²⁷, and R³²⁸ each independently represent a hydrogen atom, a halogen atom, an alkyl group, an alkoxy group, an aryl group, a group represented by general formula (A-1), or a group represented by general formula (A-2) provided that the number of the crosslinkable groups in the compound is six or more.

6. The organic electroluminescent device according to claim 1, wherein the composition further contains a radical generating agent selected from the group consisting of a thermal radical generating agent and a photo-radical generating agent.

7. The organic electroluminescent device according to claim 6, wherein 0.1 to 25 parts by mass of the thermal radical generating agent is contained relative to a total solid content of 100 parts by mass in the composition.

8. The organic electroluminescent device according to claim 6, wherein 0.001 to 10 parts by mass of the photo-radical generating agent is contained relative to a total solid content of 100 parts by mass in the composition.

9. The organic electroluminescent device according to claim 1, wherein the cured film has a volume resistivity in a range of 1×10⁵ Ω·cm to 1×10¹⁵ Ω·cm.

10. The organic electroluminescent device according to claim 1, wherein the cured film has a volume resistivity in a range of 1×10⁵ Ω·cm to 1×10¹⁰ Ω·cm.

11. The organic electroluminescent device according to claim 1, wherein the residual film ratio is 95% or more.
